(19) United States
(12) Patent Application Publication
(10) Pub. No.: US 2023/0126826 A1
(43) Pub. Date: Apr. 27, 2023

(54) TEXT CLASSIFICATION METHOD, TEXT CLASSIFICATION APPARATUS, ELECTRONIC DEVICE, STORAGE MEDIUM AND PROGRAM PRODUCT

(71) Applicant: SAMSUNG ELECTRONICS CO., LTD., Suwon-si (KR)

(72) Inventors: Xiangfeng MENG, Beijing (CN); Xiaoyan QU, Beijing (CN); Song LIU, Beijing (CN)

(73) Assignee: SAMSUNG ELECTRONICS CO., LTD., Suwon-si (KR)

(21) Appl. No.: 17/979,384

(22) Filed: Nov. 2, 2022

Related U.S. Application Data
(63) Continuation of application No. PCT/KR2022/016167, filed on Oct. 21, 2022.

(30) Foreign Application Priority Data
Oct. 26, 2021 (CN) 202111250342.5

(51) Int. Cl. G06F 40/20; G06N 3/04; G06F 40/166

(52) U.S. Cl. CPC G06F 40/20; G06N 3/0472; G06F 40/166

(57) ABSTRACT

A text classification method includes acquiring a text to be classified, obtaining a feature representation of the text to be classified by performing feature extraction on the text to be classified, acquiring a tuple set of each current text class, the tuple set of each text class comprising a prototype of each respective text class and a distribution density of text data of each respective text class, and obtaining a text class of the text to be classified by classifying the text to be classified based on the feature representation of the text to be classified and the tuple set.

### CROSS-REFERENCE TO RELATED APPLICATION(S)

This application is a continuation of International Application No. PCT/KR2022/016167, filed on Oct. 21, 2022, in the Korean Intellectual Property Receiving Office, which is based on and claims priority to Chinese Patent Application No. 202111250342.5, filed on Oct. 26, 2021 in the Chinese Patent Office, the disclosures of which are incorporated by reference herein in their entireties.

### TECHNICAL FIELD

The present disclosure relates generally to information processing, and in particular, to a text classification method, a text classification apparatus, an electronic device, a storage medium and a program product.

### BACKGROUND

The text classification technology is an information processing technology that may provide orderly organization for text. As a core technology emphasized in natural language processing, information retrieval, data mining and other fields, the text classification technology has developed vigorously in recent years and has been widely applied in various scenarios.

However, there are opportunities for improvement in the classification effect since the text classification technology has been researched, especially the text classification technology applied in mobile devices. Therefore, techniques to improve the classification effect are being pursued.

### SUMMARY

Provided are a text classification method, a text classification apparatus, an electronic device, a storage medium and a program product, in order to improve the text classification effect.

Additional aspects will be set forth in part in the description which follows and, in part, will be apparent from the description, or may be learned by practice of the presented embodiments.

According to an aspect of the disclosure, a text classification method may include acquiring a text to be classified. A text classification method may include obtaining a feature representation of the text to be classified by performing feature extraction on the text to be classified. A text classification method may include acquiring a tuple set of each current text class, the tuple set of each text class including a prototype of each respective text class and a distribution density of text data of each respective text class. A text classification method may include obtaining a text class of the text to be classified by classifying the text to be classified based on the feature representation of the text to be classified and the tuple set.

According to an aspect of the disclosure, a text classification apparatus may include a text acquisition module configured to acquire a text to be classified. A text classification apparatus may include a feature extraction module configured to obtain a feature representation of the text to be classified by performing feature extraction on the text to be classified. A text classification apparatus may include a set acquisition module configured to acquire a tuple set of each current text class, the tuple set of each text class including a prototype of each respective text class and a distribution density of text data of each respective text class. A text classification apparatus may include a text classification module configured to obtain a text class of the text to be classified by classifying the text to be classified based on the feature representation of the text to be classified and the tuple set.

According to an aspect of the disclosure, a non-transitory computer-readable storage medium may store instructions that, when executed by a processor, cause the processor to acquire a text to be classified. a non-transitory computer-readable storage medium may store instructions that, when executed by a processor, cause the processor to obtain a feature representation of the text to be classified by performing feature extraction on the text to be classified. A non-transitory computer-readable storage medium may store instructions that, when executed by a processor, cause the processor to acquire a tuple set of each current text class, the tuple set of each text class including a prototype of each respective text class and a distribution density of text data of each respective text class. A non-transitory computer-readable storage medium may store instructions that, when executed by a processor, cause the processor to obtain a text class of the text to be classified by classifying the text to be classified based on the feature representation of the text to be classified and the tuple set.

### BRIEF DESCRIPTION OF DRAWINGS

The above and other aspects, features, and advantages of certain embodiments of the present disclosure will be more apparent from the following description taken in conjunction with the accompanying drawings, in which.

FIG. 1 is a flowchart of a text classification method according to an embodiment;

FIG. 2 is a diagram of text classification by considering only the prototype according to an embodiment;

FIG. 3 is a flowchart of a training method according to an embodiment;

FIG. 4 is a diagram of a computing prototype according to an embodiment;

FIG. 5 is a diagram of an online adaptive text classification framework based on a prototype and a distribution density according to an embodiment;

FIG. 6 is a diagram of the dynamic change of user requirements according to an embodiment;

FIG. 7 is a diagram of a static text classification framework based on a prototype and a distribution density according to an embodiment;

FIG. 8 is a diagram of the introduction of a prototype and density metric learning (PDML) module according to an embodiment;

FIG. 9 is a diagram of an example of short message classification according to an embodiment;

FIG. 10 is a diagram of the introduction of an online density estimation module according to an embodiment;

FIG. 11 is a diagram of the introduction of an external information module according to an embodiment;

FIG. 12 is a diagram of the online density estimation module according to an embodiment;

FIG. 13A is a diagram of representing a large class by a single prototype according to an embodiment;

FIG. 13B is a diagram of representing a large class by multiple prototypes according to an embodiment;

FIG. 14 is a flowchart of a multi-prototype (multi-density) mechanism according to an embodiment;

FIG. 15 is a diagram of a triplet pseudo-Siamese Network model according to an embodiment;

FIG. 16 is a diagram of another example of short message classification according to an embodiment;

FIG. 17 is a diagram of an application scenario according to an embodiment;

FIG. 18 is a schematic structure diagram of a text classification apparatus according to an embodiment of the present disclosure; and

FIG. 19 is a schematic structure diagram of an electronic device according to an embodiment of the present disclosure.

### DETAILED DESCRIPTION

The embodiments of the present disclosure will be described below with reference to the drawings in the present disclosure. It will be understood that the implementations described below with reference to the drawings are illustrative description used for explaining the technical solutions in the embodiments of the present disclosure, rather than limiting the technical solutions in the embodiments of the present disclosure.

It will be understood by those skilled in the art that, as used herein, the singular forms “a”, “an” and “the” may be intended to include plural forms as well, unless otherwise stated. It will be further understood that the term “comprise/comprising” or “include/including” used in the embodiments of the present disclosure refers that the corresponding features may be implemented as the presented features, information, data, steps, operations, elements and/or components, but does not exclude that they are implemented as other features, information, data, steps, operations, elements, components and/or combinations thereof supported in the art. It will be understood that, when an element is “connected to” or “coupled to” to another element, this element may be directly connected to or coupled to the another element, or this element may be connected to the another element through an intermediate element. In addition, as used herein, the “connection” or “coupling” may include wireless connection or wireless coupling. As used herein, the term “and/or” indicates at least one of the items defined by this term. For example, “A and/or B” is implemented as “A”, “A” or “A and B”.

To make the objectives, technical solutions and advantages of the present disclosure clearer, the implementations of the present disclosure will be further described in detail below with reference to the drawings.

An embodiment of the present disclosure provides a text classification method. This method is deployed in a mobile device. For example, this method may be executed by a text classification engine deployed in the mobile device. In practical applications, the mobile devices may include a mobile phone, a smart phone, a tablet computer, a notebook computer, a smart speaker, a smart watch, a personal digital assistant, a portable multimedia player, etc. It will be understood by those skilled in the art that, except for elements special for mobile purpose, the configurations according to the embodiments of the present disclosure can also be applied to a fixed type of terminals, such as desktop computers or digital TV sets.

Firstly, several terms involved in the present disclosure will be explained below.

(1) Prototypical: it is a parameter representation derived from metric learning. The metric learning is also called similarity learning that is to measure the similarity between data. That is, the smaller the distance between data of a same class is, the larger the distance between data of different classes is. On this basis, a mean point, i.e., a prototype, may be calculated according to the data of a same class to represent this class.

(2) Distribution or distribution density or data distribution density: it is used to measure the distribution of data, for example, data concentration, data dispersion, data distribution moderation or the like.

(3) Online inference: it refers to a process of classifying the new text by deployed text classification engine after a user newly inputs/receives a text during user interaction.

(4) Online training: it refers to a method in which the user will input some data during user interaction, for example, newly adding a text class of the text and newly adding the text into the text class. At this time, the patterns of the new user-defined text class may be learnt according to these data input by the user, and the deployed text classification engine may be updated on the mobile phone.

(5) Offline training: the offline training refers to a process of training the offline model based on labeled text training data. Once the model is trained and deployed into the mobile phone, the model on the mobile terminal will not change any more until the next version of the text classification engine is uniformly updated.

The technical solutions in the embodiments of the present disclosure and the technical effects achieved by the technical solutions in the present disclosure will be explained below by describing several exemplary implementations. It is to be noted that the following implementations may refer to or learn from each other or be combined with each other, and the same terms, similar features and similar implementation steps in different implementations will not be repeated.

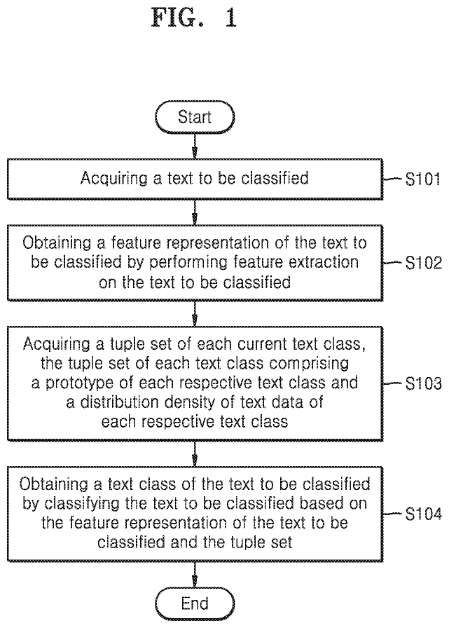

FIG. 1 is a flowchart of a text classification method according to an embodiment. An embodiment of the present disclosure provides a text classification method, which is applicable to the online inference process. As shown in FIG. 1, the method includes the following operations.

In operation S101, a text to be classified is acquired.

The text to be classified refers to a text whose text class is to be labeled, and thus can also be called a text to be labeled.

Specifically, the acquired text to be classified may be a text newly input by the user. For example, the user adds a short text to the note software of the mobile phone. Or, the acquired text to be classified may be a text newly received by the user. For example, the user newly receives a short message.

In an embodiment of the present disclosure, the type of the text to be classified is not specifically limited. For example, the type of the text to be classified may include, but not limited to, short message, note, file, browser bookmark, e-mail or the like.

In operation S102, a text classification apparatus may obtain a feature representation of the text to be classified by performing feature extraction on the text to be classified.

feature extraction is performed on the text to be classified to obtain a feature representation of the text to be classified.

The feature representation of the text refers to that the feature of the text is represented in a certain form, for example, vector or the like. Specifically, the feature representation of the text may be a coded representation, an original text feature or an optimized text feature of the text, for example, a text feature mapped to a target space.

In an embodiment, feature extraction is performed on the text to be classified (e.g., by a neural network) to obtain a feature representation, then the text feature of the text to be classified is mapped to a target space (that is, the text feature is converted into a feature vector representation in the target space).

In another optional implementation, the text to be classified is coded (e.g., by a certain text representation algorithm) to obtain a coded representation of the text to be classified; feature extraction is performed on the coded representation (e.g., by feature engineering) to obtain a (original) text feature; and, the text feature is mapped to a target space (that is, the text is converted into a feature vector representation in the target space) to obtain a feature representation of the text to be classified.

In operation S103, a text classification apparatus may acquire a tuple set of each current text class, the tuple set of each text class comprising a prototype of each respective text class and a distribution density of text data of each respective text class.

A tuple set of each current text class is acquired, the tuple set of each text class including the prototype of this text class and the distribution density of text data of this text class.

The tuple set of each text class is obtained by (online or offline) training and learning based on labelled texts, including the prototypes and distribution densities of all existing text classes. The information may be used for the online inference of the text to be classified.

In operation S104, a text classification apparatus may obtain a text class of the text to be classified by classifying the text to be classified based on the feature representation of the text to be classified and the tuple set.

The text to be classified is classified based on the feature representation of the text to be classified and the tuple set to obtain a text class of the text to be classified.

That is, in an embodiment of the present disclosure, the classification is performed on the text to be classified by a prototype and density metric learning scheme (which can also be constructed as a prototype network model based on prototype and distribution density) to finally output a text class of the text to be classified.

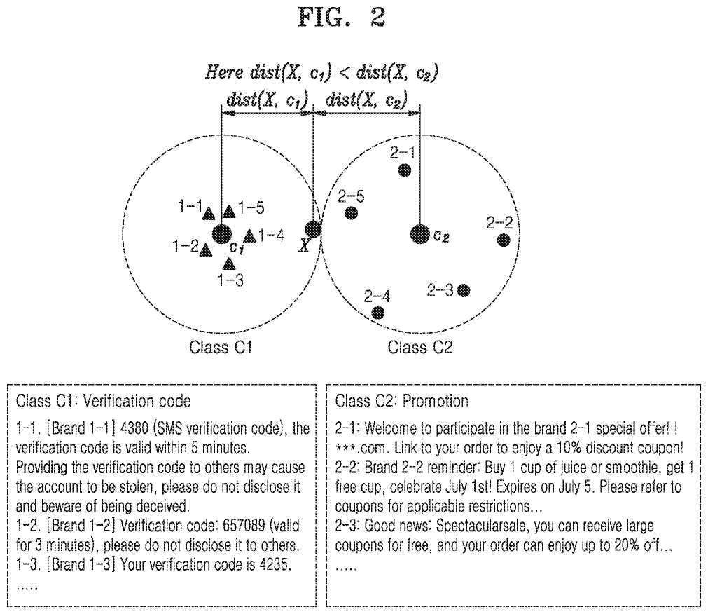

FIG. 2 is a diagram of text classification by considering only the prototype according to an embodiment. By taking the classification of short messages on the mobile phone as an example, as shown in FIG. 2, class C1 is notification short messages about verification codes, including five texts (1-1 to 1-5). Sample points corresponding to the five texts closely surround their prototype (C1). Class C2 is promotion-related short messages, where the distribution of five sample points (2-1 to 2-5) is relatively sparse. It will be understood that the text shown in FIG. 2 is merely schematic and the solution of the present disclosure does not focus on the specific text content and type. That is, the specific content and specific type of the text does not affect the implementation of the solution of the present disclosure. At this time, for a new text X to be classified, the distance (“dist” for short) to prototypes of two classes satisfies the following: distance(X, C₁)<distance(X, C₂). If the distribution density is not taken into consideration, X is classified into class C1. However, in fact, it is more possible that X belongs to class C2. Therefore, in an embodiment of the present disclosure, in addition to the position of the prototype, the distribution density of data of each text class will also be taken into consideration during text classification, in order to improve the accuracy of classification.

In an embodiment of the present disclosure, based on the prototype, the text to be classified may be classified by determining which prototype in the tuple set is closest to the text to be classified in the target space. Based on the distribution density, for a text class having a more concentrated data distribution, there are higher requirements for adding a new points (in an embodiment of the present disclosure, one points may refer to a text, and the same content will not be described below) (classifying the text to be classified into this text class). That is, only when the new points is close enough to the prototype of this text class, the new points will be classified into this text class. However, for a text class having a relatively disperse data distribution, the requirements are less for adding a new points.

The text classification method according to an embodiment of the present disclosure may be used for online inference after learning from small samples, and has the advantage of small sizes. Compared with methods that ignores the distribution density of data of each text class in the prior art, in an embodiment of the present disclosure, both the prototype of each text class and the data distribution density are taken into consideration during the classification process, and the classification of the text to be classified may be realized using small data based on two factors, i.e., prototype and distribution density, thereby improving the efficiency and accuracy of classification.

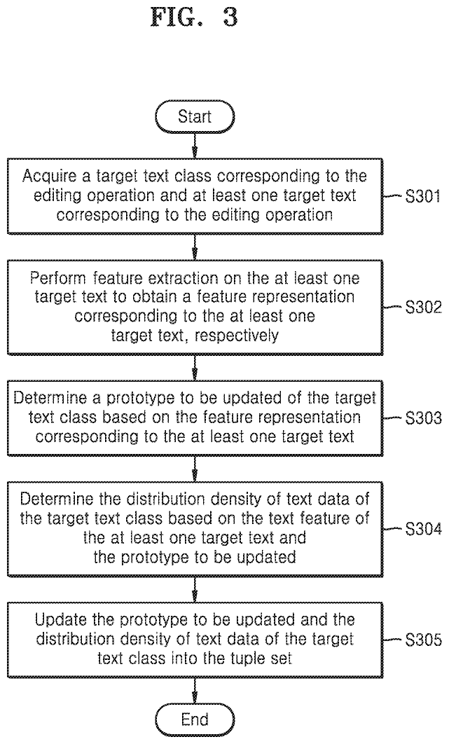

FIG. 3 is a flowchart of a training method according to an embodiment. In an embodiment of the present disclosure, the tuple set (or a model containing the tuple set) of each text class in operation S103 may be obtained by online training and learning. In other words, before operation S103, the text classification method may further include, based on an editing operation for a text class being received, as shown in FIG. 3, executing the following process to obtain a tuple set.

In operation S301, a target text class is added by the editing operation and at least one target text corresponding to the editing operation are acquired into the new target text class.

In an embodiment of the present disclosure, every time an editing operation for a text class is received, the online training process may be triggered. Optionally, the editing operation for a text class may be newly adding a text class and adding text data to this newly added text class; or, the editing operation for a text class may also be adding new text data to an existing (non-newly-added) text class; or, the editing operation for a text class may also be other operations. It will not be limited in the embodiments of the present disclosure.

It will be understood that, if the editing operation is newly adding a text class and adding text data to this newly added text class, the target text class corresponding to the editing operation is the newly added text class, and the at least one target text corresponding to the editing operation is the text data added to the newly added text class. If the editing operation is adding new text data to a non-newly-added text class, the target text class corresponding to the editing operation is the non-newly-added text class, and the at least one target text corresponding to the editing operation is the text data added to the non-newly-added text class. The editing operations in other cases are analogized, and will not be repeated here.

In operation S302, feature extraction is performed on the at least one target text to obtain a feature representation corresponding to the at least one target text, respectively.

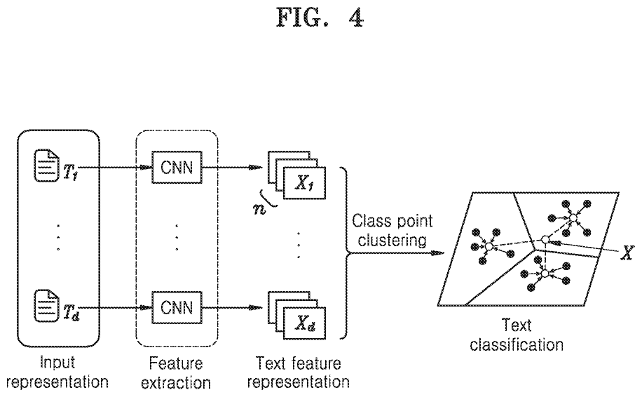

FIG. 4 is a diagram of a computing prototype according to an embodiment. In one implementation, as shown in FIG. 4, for each target text (T₁ to T_{d}) in the at least one target text, the step may specifically include: performing feature extraction on the target text (by a convolutional neural network (CNN) in FIG. 4) to obtain a text feature representation (corresponding to X₁ to X_{d} in FIG. 4), and then the target text feature is mapped to the target space. In the target space, the data of the same text class is mapped to adjacent positions.

In operation S303, a prototype to be updated of the target text class is determined based on the feature representation corresponding to the at least one target text.

One optional way is that weighted averaging is performed on the feature representation corresponding to the at least one target text to obtain a prototype to be updated of the target text class.

Since the at least one target text corresponds to a same target text class, a mean point may be calculated based on the text data of the at least target text. That is, a weighted average of a vector mapping these target texts to the target space is calculated based on a number of target text data input by the user, to obtain a prototype to be updated of the target text class, i.e., the prototype of the target text class currently in the target space (while may be a certain one of c₁ to c₃, the remaining two prototypes may be prototypes of other text classes learnt previously). This process may also be referred to as class point clustering, and the obtained prototype is used for text classification.

It will be understood that X in FIG. 4 is text data to be classified that is newly obtained during the online inference process. The text data to be classified may be classified by determining which prototype closest to the new data in the target space.

In operation S304, the distribution density of text data of the target text class is determined based on the text feature of the at least one target text and the prototype to be updated.

Specifically, the distribution density estimation of text class of the target text class could be implemented as the variance estimation of the text data of the target text class.

In operation S305, the prototype to be updated and the distribution density of text data of the target text class are updated into the tuple set.

The obtained prototype of the target text class to be updated and the distribution density of text data of the target text class are updated into the tuple set (or model). The prototypes and data distribution densities of all existing text classes contained in the tuple set (or model) will be used for the online inference process.

In an embodiment of the present disclosure, for operation S305, the updating of the tuple set (or model) may include at least one of the following situations.

If the target text class corresponding to the editing operation is a newly added text class, the prototype to be updated is used as the prototype of the target text class, and the prototype to be updated and the distribution density of text data of the target text class are added to the tuple set. That is, the tuple set (or model) originally does not contain information related to the target text class, and the information needs to be newly added.

If the target text class corresponding to the editing operation is a non-newly-added text class, the historical prototype of the target text class in the tuple set is acquired, and the historical prototype in the tuple and the historical distribution density corresponding to the target text class are updated according to the prototype to be updated, the historical prototype and the distribution density of text data of the target text class. That is, the tuple set (or model) already contains the information related to the target text class, and the information related to the target text class needs to be adjusted with the new text continuously added by the user.

Specifically, the historical prototype in the tuple set may be updated by using the weighted average of the prototype to be updated and the historical prototype. The historical distribution density corresponding to the target text class in the tuple set may be updated by directly using the determined distribution density of text data of the target text class.

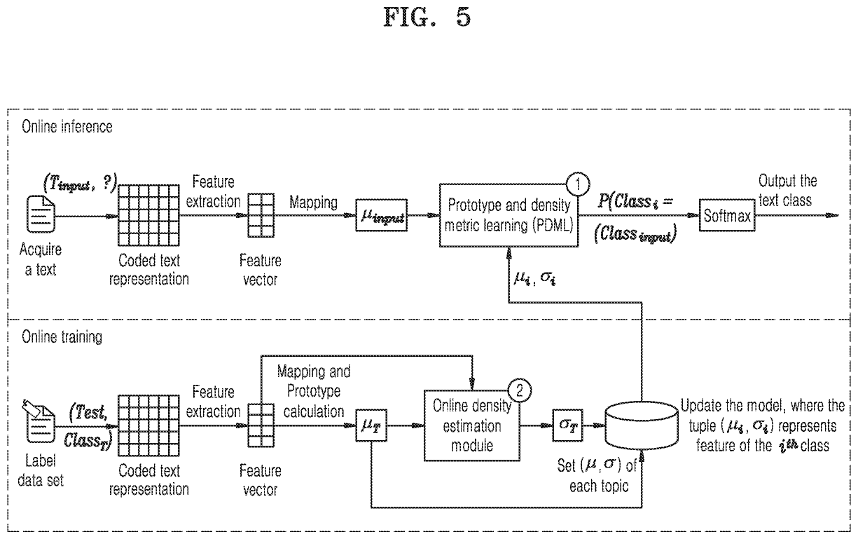

FIG. 5 is a diagram of an online adaptive text classification framework based on a prototype and a distribution density according to an embodiment. As shown in FIG. 5, the online adaptive text classification framework based on prototype and distribution density according to an embodiment of the present disclosure includes two core modules, i.e., online training and online inference. The online training mainly includes the following operations.

(1) The data input by the user is used as a labeled data set (Text, Class_{T}), for example, a new text class and text data added to this text class by the user, or text data newly added to an existing text class by the user, or the like.

(2) The input text data is coded and represented by a certain text representation algorithm; and, feature extraction is performed on the coded representation by a feature engineering idea, and the obtained original feature vector is mapped to the target space. Or, the input text may be directly converted into a feature vector in the target space. Typical algorithms include neural network layers such as CNN.

(3) The prototype μ_{T} (i.e., the weighted average of vectors after these texts are mapped to the target space) of the target class in the target space is calculated based on the text data input by the user.

(4) The distribution density of data of the text class is estimated by an online density estimation module, and a sample variance estimation σ_{T} of the text class is output.

(5) The tuple (prototype and distribution density) of the text class is added to the model. The model contains the prototypes and distribution densities of all existing text classes, i.e., each text class (μ, σ) set. The tuple (μᵢ, i) represents the feature of the i^{th} text class, and will be used for the online inference process.

The online inference process includes the following operations.

(1) A text (Tᵢₙₚᵤₜ, ?) is acquired. The text may be a new text input by the user or a new text received by the user. For example, the user adds a short text to the note software of the mobile phone, or the user newly receives a short message.

(2) The text is coded and represented by a text representation module; and, the coded representation of the text is subjected to feature extraction by feature engineering and then mapped to the target space. Or, the text may be directly converted into a feature factor in the target space, such that the feature representation μᵢₙₚᵤₜ of the text may be obtained.

(3) The inference is performed on the text according to the set (μ, σ) of each text class by a prototype and density metric learning algorithm, to obtain P (Classᵢ=Classᵢₙₚᵤₜ).

(4) The text class of the text is output by a softmax (classifier) layer.

The tuple set (or model) based on prototype and distribution density according to an embodiment of the present disclosure consumes less computing resources during learning and updating, has high updating speed, and may be better applied to mobile devices such as mobile phones

Moreover, for the online training mode according to an embodiment of the present disclosure, the online training may be completed based on only one or few pieces of data provided by the user. That is, this embodiment of the present disclosure provides a low-energy-consumption model that can realize effective learning on small sample data, such that it is further better applied to mobile devices such as mobile phones.

In addition, this embodiment of the present disclosure adopts a dynamically updated adaptive text classification engine on the device side, and adopts an online training mode, such that online model updating may be performed according to different data of different users of each mobile phone. Thus, it is beneficial to learn the user's latest preference information in real time, thereby realizing the user's personalized demand and dynamic updating, and solving the influence on user experience caused by lack of personalization and invariability.

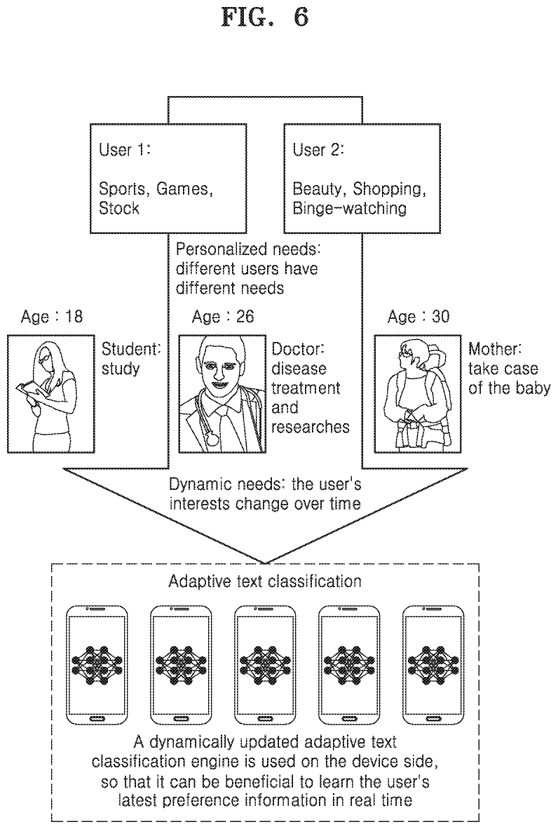

FIG. 6 is a diagram of the dynamic change of user requirements according to an embodiment. Exemplarily, as shown in FIG. 6, different users have different topics of interest. For example, some users (e.g., user 1) may be more interested in sports, stocks, cars, games or the like, while some users (e.g., user 2) may be more interested in shopping, binge-watching, beauty or the like. Therefore, the text contents browsed by different users and the text contents received by different users will greatly differ from each other. However, in the conventional text classification, text classes are predefined and all users share a same text class set, so it could not cover all users' requirements at the same time.

Secondly, different users will have different grouping preferences when classifying text. For example, a first user tends to classify financial notification short messages, parenting notification short messages, and vaccination notification short messages or the like into the same short message class “Important Notification”, while a second user will classify the three types of short messages into different classes. However, in the conventional text classification, the criterion for classification is the same for all users and will not change with the user's personalized need.

In view of the above situation, the embodiment of the present disclosure can support user-defined classes and realize learning on the mobile terminal by using the adaptive text classification method for online training (for example, the dynamically updated adaptive text classification engine is deployed on the device side), thereby adjusting according to different users' preferences (e.g., class preferences or text classification preferences).

Furthermore, a user's topic of interest will change over time. For example, when the user was a college student at the age of 18, the user's topic of interest was mainly related to study; when the user began to work as a doctor at the age of 26, the user's topic of interest was disease treatment and researches; and, when the user became a mother at the age of 30, the user began to pay attention to parenting related topics.

In view of the above situation, the embodiment of the present disclosure can trace the latest text class preference and text classification preference of the user in time by using the adaptive text classification method for online training (for example, the dynamically updated adaptive text classification engine is deployed on the device side), thereby realizing self-updating according to the user's feedback in real time.

In other embodiments, the tuple set (or a model containing the tuple set) of each text class in operation S103 may be obtained by offline training and learning. It will not be limited in the embodiments of the present disclosure. Advantageously, the offline training can support large-scale neural network training.

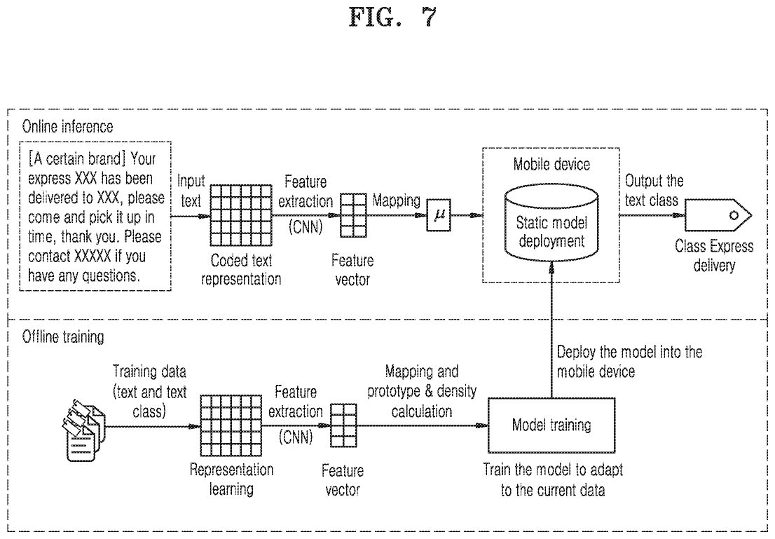

FIG. 7 is a diagram of a static text classification framework based on a prototype and a distribution density according to an embodiment. Exemplarily, as shown in FIG. 7, this framework mainly includes two parts: offline training and online inference.

During the offline training, the training data (text, text class) is given. First, the text is represented by a representation learning technology. Since the target is to be deployed on a mobile device, a light-weight learning method may be used, for example, English char embedding, Chinese radical embedding or the like. Such coding methods can effectively reduce the model size. Then, features in the text are extracted by CNN or other technologies, or the text is directly converted into a feature vector in the target space by CNN or other technologies. Subsequently, the prototype and distribution density of each text class in the target space are calculated, and the model is trained to adapt to current data, such that the model is deployed in the mobile device.

During the online inference, when a next text is input, the text is coded and represented by a representation learning technology, and then features of the text are extracted by a CNN and mapped to the target space; or, the new text is directly converted into a feature vector in the target space by CNN or other technologies. A feature presentation μ of the text is calculated, the class is predicted by a statically deployed model and a softmax layer, and a result of text classification is finally output. It will be understood that, the text shown in FIG. 7 is merely schematic, and the solution of the present disclosure does not focus on the specific text content and type. That is, the specific content and specific type of the text does not affect the implementation of the solution of the present disclosure.

In an embodiment of the present disclosure, the improvements to the prior art will be described by the prototype and density metric learning (PDML) module labeled with \textcircled{1} in the framework shown in FIG. 5.

In the conventional text classification, a (text) points to be classified is newly input, and the model performs classification according to the feature of the (text) points by analyzing the probability that the (text) points belongs to each text class. However, in the improvement a \textcircled{1}, hypothesis testing is introduced into the classification inference module, such that the classification problem becomes a statistical hypothesis testing problem and the text is classified by the hypothesis testing idea.

Specifically, for the existing text classes, each text class includes few support data points (i.e., text data initially owned by each text class). In an embodiment of the present disclosure, the set of support data points in each text class is regarded as a result of independent sampling in a certain Gaussian distribution. Corresponding to operation S104, the text classification method may specifically include the following operations: using the feature representation of the text to be classified as a center of a Gaussian distribution, and determining a probability that the text data of each text class is sampled from the Gaussian distribution; and, classifying the text to be classified based on each determined probability.

In other words, in the PDML module, it is assumed that the new input text to be classified (i.e., the position of the text to be classified mapped to the target space) is a center of a certain Gaussian distribution, the probability that the set of support data points in each text class is sampled from this distribution is estimated by hypothesis testing. If the probability that the set of support data points in a certain text class is sampled from this distribution is higher, the probability that the text to be classified belongs to this text class is also higher.

In one implementation, the process of determining a probability that the text data of each text class is sampled from the Gaussian distribution includes: for each text class, determining the hypothesis testing statistic of the text data of this text class sampled from the Gaussian distribution, according to the number of text data of this text class, the tuple set of this text class and the feature representation of the text to be classified; and, determining the probability corresponding to each text class according to the hypothesis testing statistic corresponding to each text class.

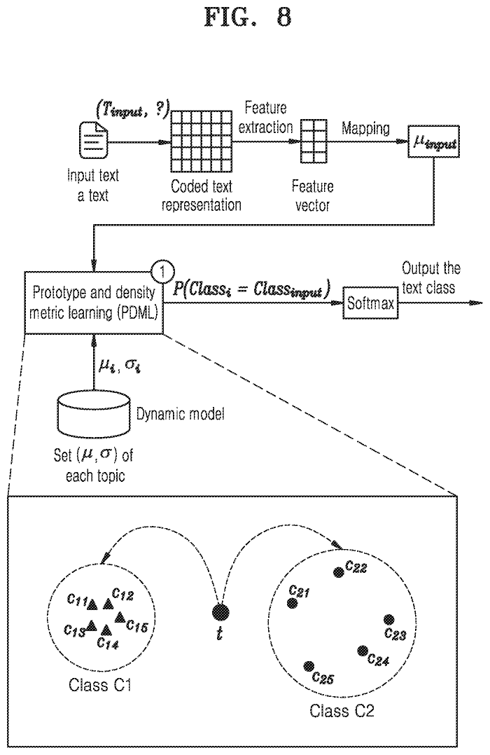

FIG. 8 is a diagram of the introduction of a PDML module according to an embodiment. As shown in FIG. 8, how to estimate the probability that the set of support data points in each text class is sampled from the distribution will be explained by taking a student's t test as an example.

The newly acquired text to be classified is given and coded to obtain a coded representation vector of the text to be classified. The representation vector is inputted into to feature extraction module and then mapped to the target space; or, the new text is directly converted into a feature vector in the target space by CNN or other technologies. The coordination mapped to the target space is recorded as μᵢₙₚᵤₜ.

Further, inference is performed by the PDML according to an embodiment of the present disclosure. Specially, the coordination (μᵢₙₚᵤₜ) mapped to the target space is regarded as a center t of a Gaussian distribution, and the variance of this distribution is unknown. That is, the distribution is N(μᵢₙₚᵤₜ, σ_{unknown}).

For a certain known text class i, this text class contains nᵢ support data, and the nᵢ support data have a sample mean of μᵢ and a sample variance of σᵢ. Based on the t-hypothesis test, the t-statistic (hypothesis testing statistic) of the support data of this known text class sampled from the distribution N(μᵢₙₚᵤₜ, σ_{unknown}) is, as in Equation (1):

$${s}_{i} = \frac{{μ}_{i} - {μ}_{input}}{{σ}_{i} / \sqrt{{n}_{i}}} \qquad ( 1 )$$

where μᵢ−μᵢₙₚᵤₜ corresponds to the influence of the data center (prototype) on the text classification, and σᵢ/\sqrt{nᵢ} corresponds to the influence of the data distribution density on the text classification.

For example, in FIG. 8, it is assumed that the text t to be classified is a center of a certain Gaussian distribution, μᵢₙₚᵤₜ=t; and, it is assumed that five points in class C1 or C2 are all separately sampled from the Gaussian distribution, the hypothesis testing statistics when the two point sets are separately sampled are calculated, respectively.

Further, the confidence corresponding to each statistic may be obtained by table lookup (student's t test for hypothesis testing, or critical value table). The confidence may be used as a probability, i.e., a probability that the data point set in each text class is sampled from the Gaussian distribution, as in Equation (2).

P(Classᵢ=Classᵢₙₚᵤₜ|Sᵢ) (2)

The probability is input to the subsequent softmax layer to infer the final result of classification.

Compared with the one-model-fits-all approach (only considering which prototype of the existing text classes is most close to the new data point, then the new data point will be classified into this text class), in the text classification method according to the embodiment of the present disclosure, the PDML module shifts the original classification boundary (i.e., the numerator part, the classification boundary based on Euclidean distance is a straight line between two prototypes) through the denominator part in the above formula to some extents. This shift depends on the number of existing support samples and the sample variance of each text class.

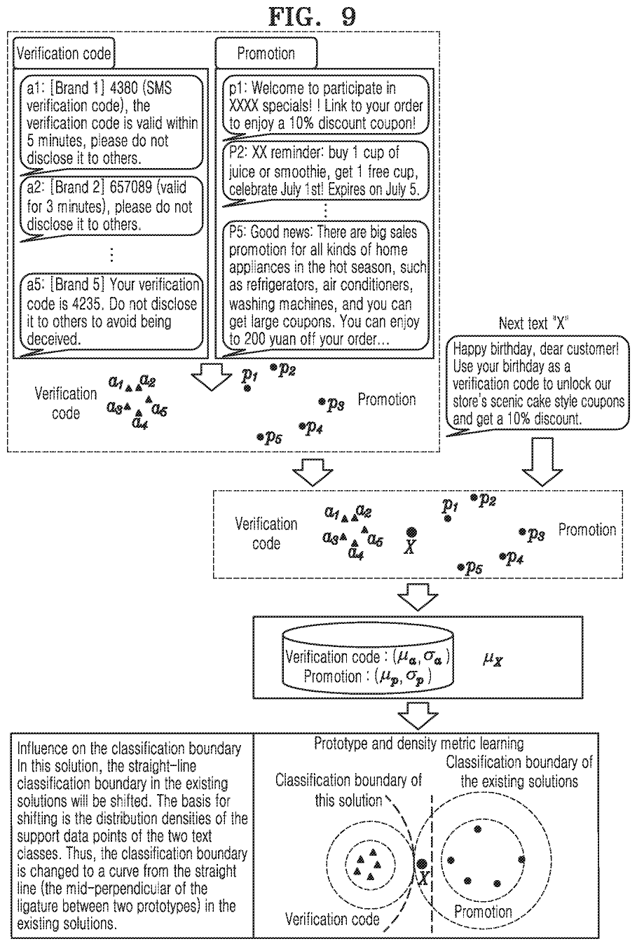

FIG. 9 is a diagram of an example of short message classification according to an embodiment. The classification boundary is finally shifted from a straight line to a curve, as shown in FIG. 9. Since the classification boundary is affected by the number of existing support samples and the ample variance of each text class, the classification boundary will be adjusted in real time when the user data is newly added continuously.

It is to be noted that, the dynamic mode in FIG. 8 may include the set (μ, σ) of each text class and the PDML module, where the set (μ, σ) of each text class may be dynamically updated online; and, the PDML module will fully consider the distribution of support data in each text class, can effectively identify the data distribution feature of each text class, and will also dynamically adjust the classification boundary in real time for subsequently text classification inference when the user data is constantly added. The both can achieve the self-adaptation and personalization of the model.

FIG. 9 also shows a specific example of the improvement \textcircled{1}. This example is a short message classification scenario, where there are two short message classes, i.e., verification code and promotion, and each short message class contains 5 texts. In the verification code class, the short message contents are similar, so the distributions in space are relatively dense (a₁ to a₅); while in the promotion class, short messages are obviously different in content, so the distributions in space are relatively disperse (p₁ to p₅). When a new short message content (new text X) is added, and when the new short message content contains a verification code and a promotion content, the new short message content will be classified into the verification code class if the state-of-art technologies are used. Since the similarity between verification code contents is extremely high, this classification is not accurate. However, in the prototype and density metric learning according to an embodiment of the present disclosure, after both the prototypes and distribution densities (μₐ, σₐ) and (μₚ, σₚ) of the support data of the text classes are taken into consideration, the straight-line classification boundary in the existing solutions will be shifted. The basis for shifting is the distribution densities of the support data points of the two text classes. Thus, the classification boundary is changed to a curve from the straight line (the mid-perpendicular of the ligature between two prototypes) in the existing solutions, and the short message X may be correctly classified into the promotion class. It will be understood that, the text shown in FIG. 9 is merely schematic, and the solution of the present disclosure does not focus on the specific text content and type. That is, the specific content and specific type of the text does not affect the implementation of the solution of the present disclosure.

As described above, the dynamic model can introduce the distribution density of data into the classification inference process of the text. However, in practical scenarios, the estimation of density as the denominator is very challenging. On one hand, when the user defines a new text class, it is possible that users provide only one support data, that is, only one text is put into the new text class. At this time, it is difficult to estimate the distribution density of the text class. On the other hand, even if the user provides a few support data, there may be errors in the estimation of distribution density in the case of small samples. In an embodiment of the present disclosure, the online density estimation module labeled with \textcircled{2} in the framework shown in FIG. 5 and how to accurately estimate the distribution density of the target text class based on one or few texts provided by the user will be described.

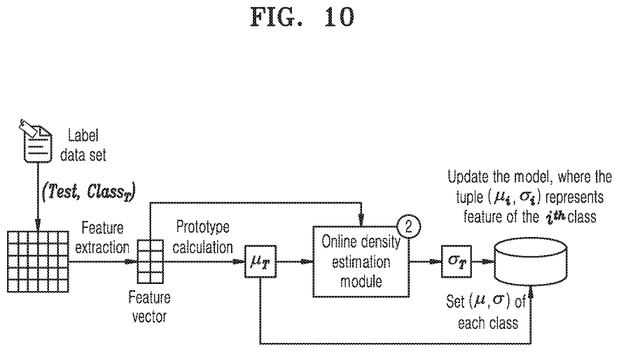

FIG. 10 is a diagram of the introduction of an online density estimation module according to an embodiment. The flowchart in an embodiment of the present disclosure is shown in FIG. 10. The specific details may refer to the description of the online training of FIG. 5 and will be not repeated here.

In an embodiment of the present disclosure, the determination of the distribution density of support data of a text class may be affected by at least one of the following three factors.

(1) The existing data of the text class.

Even if only one or a few support data are given, the distribution density of the support data of this text class can still be learnt from the one or a few support data by pre-training a generalized model. Since the user may continuously add data to this text class, the distribution density estimated based on this factor may be dynamic. Therefore, in an embodiment of the present disclosure, the latest distribution density is acquired by a long short-term memory (LSTM) structure.

In one implementation, operation S304 may specifically include: performing time-sequence feature extraction on the text feature of the at least one target text by a first LSTM network to obtain a text feature containing time-sequence information of the at least one target text; and, determining the distribution density of text data of the target text class based on the text feature containing time-sequence information of the at least one target text and the prototype to be updated.

(2) The distribution density of data of other similar text classes.

Considering that similar text classes generally have some similar features, when only few training data is given, the distribution density of other similar text classes may be transferred to the current text class. Therefore, in an embodiment of the present disclosure, an external information module is introduced, and a similarity calculation module is constructed to determine the similarity between two text classes.

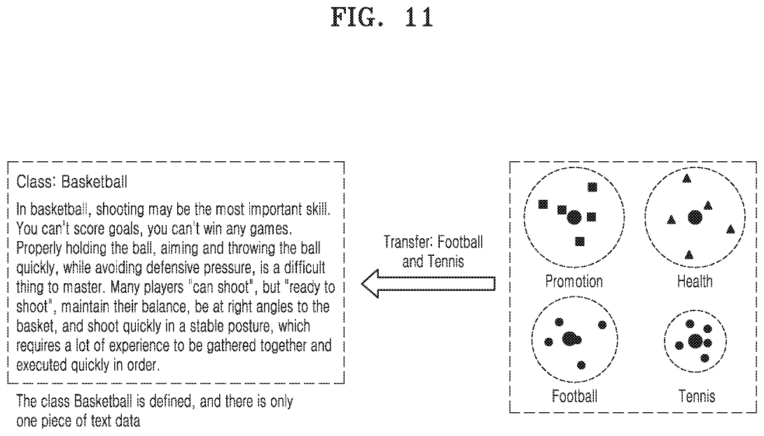

FIG. 11 is a diagram of the introduction of an external information module according to an embodiment. For example, as shown in FIG. 11, the user newly defines a class “Basketball”, and adds a text to this text class. It will be understood that, the text shown in FIG. 11 is merely schematic, and the solution of the present disclosure does not focus on the specific text content and type. That is, the specific content and specific type of the text does not affect the implementation of the solution of the present disclosure. Since there is only one text, it is difficult to estimate the distribution density information for this text class. It is found by comparison that, in the existing text classes, there are two classes “Football” and “Tennis” that are similar to the class “Basketball” and all belong to sports. It may be considered that the data distribution density information of the two classes may be transferred to the newly defined class “Basketball” for guiding the subsequent text classification process.

In one implementation, the operation S304 may specifically include: determining, according to the prototype to be updated and a tuple set of each external text classes, one or several similar text classes having a similarity greater than a threshold with the target text class; acquiring a tuple of the similar text classes; and, determining the distribution density of text data of the target text class based on the text feature of the at least one target text and the tuple of the similar text class. There may be one or more similar text classes. The external text classes are text classes except for the target text class among the text classes corresponding to the tuple set.

(3) The text data continuously added and accumulated in this text class.

In the initial stage, a newly defined text class may have only one or a few support data. At this time, the data distribution density of this text class will be greatly affected by the distribution density factor (2). As the user continuously adds text data, the influence of the factor (1) will be increased continuously, while the influence of the factor (2) will be continuously decreased. Therefore, the influences of the factors (1) and (2) on the data distribution density of the target text class are changed dynamically. In order to acquire this dynamic change feature, a second LSTM module may be introduced.

In one implementation, the determining the distribution density of text data of the target text class based on the text feature of the at least one target text and the tuple of the similar text class may specifically include: performing time-sequence feature extraction on the text feature of the at least one target text and the tuple of the similar text class by a second LSTM network, and allocating weight information of the target text class and the similar text class to obtain the distribution density of text data of the target text class.

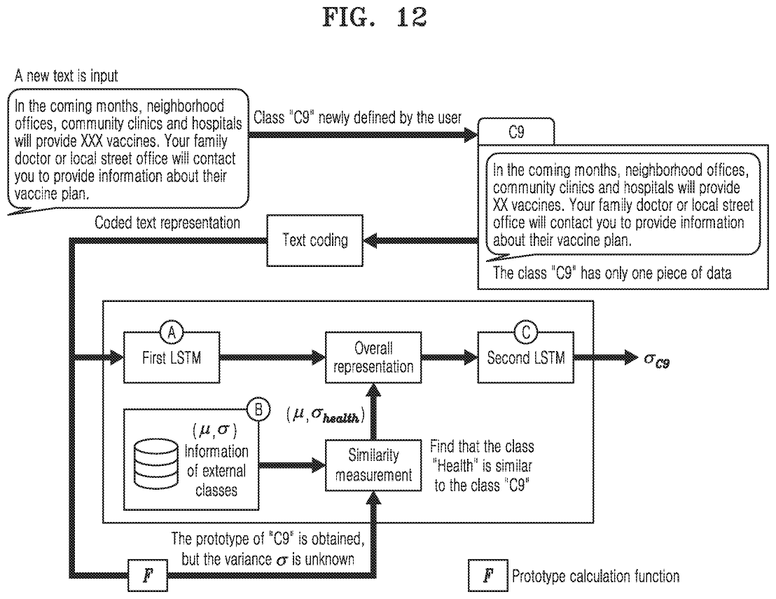

FIG. 12 is a diagram of the online density estimation module according to an embodiment. In an embodiment of the present disclosure, by comprehensively considering the three factors, an online density estimation module is proposed to estimate the data distribution density of the target text class. As shown in FIG. 12, module A corresponds to the factor (1), and mainly performs estimation based on the text that is edited into this target text class by the user; module B corresponds to the factor (2), and is mainly configured to select, from the existing text classes, a text class similar to this target text class and transfer the distribution density of the similar text class to the target text class; and, module C is an LSTM structure, and dynamically adjusts the influences of the two factors and finally outputs the data distribution density information of the target text class.

Specifically, as shown in FIG. 12, the user newly defines a text class “C9” for a new text. Assuming that there is only one text data in the class “C9”, text coding is performed on this text data to obtain a coded text representation of this text data. The coded text representation is subjected to feature extraction and then mapped to the target space (only the coded representation step is shown in FIG. 12, but it will be understood as not limiting the implementations). Or, it is also possible that the new text is directly converted into a feature vector in the target space by CNN or other technologies to obtain a text representation of the text data. The prototype of the class “C9” is calculated by a prototype calculation function, but the variance is unknown. By measuring the similarity between the external text class (μ, σ) information and the prototype of the class “C9”, it is found that the class “Health” in the external text classes is similar to the class “C9”, the tuple (μ, σₕₑₐₗₜₕ) of the class “Health” is acquired. On the other hand, the text feature of the text data is extracted by the first LSTM network to obtain a text feature vector containing time-sequence information. The text feature vector containing time-sequence information and the tuple (μ, σₕₑₐₗₜₕ) of the class “Health” are represented as a whole, and the influences of the both on the distribution density are adjusted by the second LSTM network to output the distribution density σ_{C9} of the class “C9”.

In the text classification method according to the embodiment of the present disclosure, as the user continuously inputs new text data during the interaction process, the latest distribution density of data of each text class is updated in real by the pre-trained online density estimation model.

The distribution density estimation model innovatively introduces the dynamic change of the influences of its own data and external knowledge (migration idea). The influences of the two factors on the real text classification distribution density may change over time with the continuous interaction of the user, the text data will be continuously accumulated; and, with the accumulation of data, the influence of its own data on the distribution density of its own text class will become larger and larger, while the influence of the external migration information will become smaller and smaller.

Therefore, two LSTM structures are further designed, which can effectively learn the evolution process of the influences of the two factors, thereby avoiding setting fixed weights to balance the influences of the two factors and finally reflect the accuracy of the distribution density estimation.

The distribution density estimation model according to the embodiment of the present disclosure may be executed on the basis on one or few pieces of existing data, such that the cold start (there is only one piece of support data) of the online data distribution density estimation is solved, and the data distribution density of the target text class may be accurately estimated in the case of only few samples.

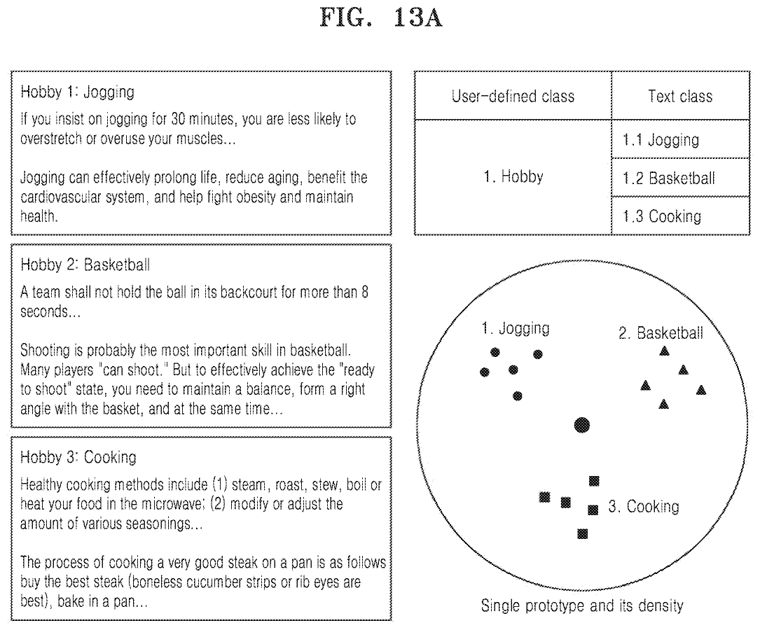

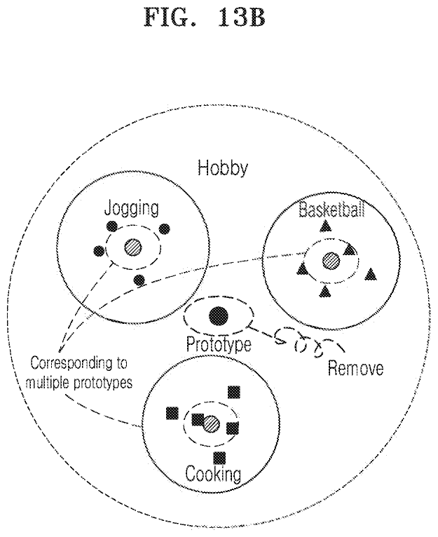

It was also found after data analysis that texts of different text classes may be classified into a same text class when the user defines text classes. For example, the user defines a text class “Important notification” which may include bank transaction or other information and also vaccination or other notifications. Such a text class contains multiple distinct text types. At this time, if this text class is represented by a single prototype, the prototype will incorrectly represent the features of this text class. For example, as shown in FIG. 13A, the user defines a class “Hobby, and adds texts related to three topics (i.e., jogging, cooking and basketball) to this text class. The text features of the three text classes are entirely different.

FIG. 13A is a diagram of representing a large class by a single prototype according to an embodiment. FIG. 13B is a diagram of representing a large class by multiple prototypes according to an embodiment.

It will be understood that, the text shown in FIG. 13A is merely schematic, and the solution of the present disclosure does not focus on the specific text content and type. That is, the specific content and specific type of the text does not affect the implementation of the solution of the present disclosure. At this time, if a prototype points is selected for representing this class, this prototype is far away from all data points, that is, this prototype points cannot represent this text class well.

In an embodiment of the present disclosure, how to solve the problem that a single prototype is difficult to effectively represent a big (text) class containing a large amount of text will be described in order to satisfy the user's personalized needs.

Specifically, an embodiment of the present disclosure provides a multi-prototype (multi-density) mechanism to solve the defect that single prototype and distribution density are difficult to accurately represent the information of text classes in a case where the user may define some big text classes and these text classes contain multiple sub-topics.

The core idea of this mechanism is that: a text class may contain multiple prototypes and multiple corresponding data distribution densities (one prototype correspond to one data distribution density), and each prototype (dada distribution density) corresponds to one text topic (which is also called a secondary text class and may be referred to as a text sub-class of the corresponding primary text class). When one (primary text class) contains new texts of multiple topics, this mechanism will automatically detect the topic contained in each text, calculate prototypes and densities for these topics, and classify these texts based on the adaptive text classification framework mentioned above. By continuously taking the scenario shown in FIG. 13A as an example. FIG. 13B shows a schematic diagram of this mechanism, where, instead of using the uniformly extracted prototypes, prototypes are extracted for the three topics Jogging, Cooking and Basketball, respectively, and the subsequent steps are then executed.

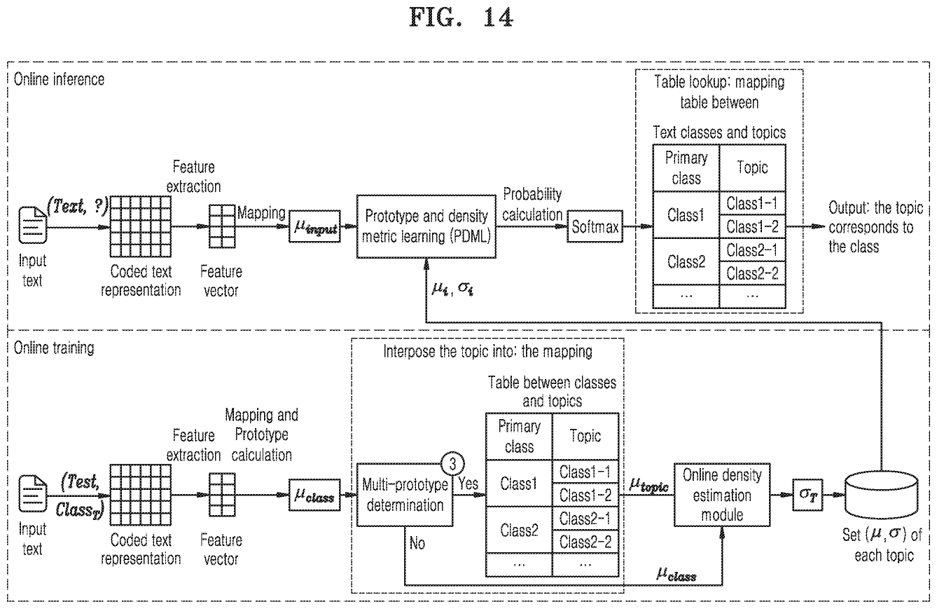

FIG. 14 is a flowchart of a multi-prototype (multi-density) mechanism according to an embodiment. In one implementation, in an embodiment of the present disclosure, a mapping table from text classes (primary text classes) to text topics (secondary text classes) is constructed and maintained (for example, as shown in by the mapping table of FIG. 14). This mapping table is a one-to-multiple relationship, that is, one text class may correspond to multiple text topics. During the classification process, text topics are used as classification targets, rather than user-defined text classes. After the topic of one text is obtained, the text class information of this text may be obtained by looking up this mapping table. In an embodiment of the present disclosure, the text topic is visible inside the model but not visible to the user; and, the text class is visible to the user but not visible to the model.

With reference to the online inference process shown in FIG. 1, in an embodiment of the present disclosure, the tuple set of each text class in operation S103 is a tuple set of each secondary text class, and may be trained and learned based on the text labeled with the secondary text class.

Similarly, the obtaining a text class of the text to be classified in operation S104 refers to obtaining a secondary text class of the text to be classified.

Further, in an embodiment of the present invention, after the secondary text class of the text to be classified is obtained, the text classification method may further include: determining a primary text class of the text to be classified according to the preset mapping table between primary text classes and secondary text classes and the secondary text class of the text to be classified.

With reference to the online training process shown in FIG. 3, the editing operation for a text class is an editing operation for a primary text class. That is, every time the editing operation for a primary text class is received, the online training process may be triggered. Optionally, the editing operation for a primary text class may be newly adding a primary text class and adding text data to this newly added primary text class; or, the editing operation for a primary text class may also be adding new text data to an existing (non-newly-added) primary text class; or, the editing operation for a primary text class may also be other operations. It will not be limited in the embodiments of the present disclosure.

Thus, the acquisition of the prototype to be updated of the target text class can still refer to operations S301 to S303, and will not be repeated here. In operation S304, for each target text in the at least one target text, the determining the distribution density of text data of the target text class based on the text feature of this target text and the prototype to be updated may specifically include determining according to the text feature of this target text and the tuple set whether there is a newly added secondary text class in the target text class, if there is a newly added secondary text class in the target text class, updating the mapping table between primary text classes and secondary text classes according to the target text class and the newly added secondary text class, and determining the distribution density of text data of the newly added secondary text class based on the text feature of this target text and the prototype of the newly added secondary text class, and if there is no newly added secondary text class in the target text class, determining a secondary text class to be updated corresponding to this target text, and determining the distribution density of text data of the secondary text class to be updated based on the text feature of this target text and prototype to be updated of the secondary text class to be updated.

Further, the updating the prototype to be updated and the distribution density of text data of the target text class into the tuple set includes at least one of the following: adding the prototype corresponding to the newly added secondary text class and the distribution density of text data into the tuple set, and acquiring a historical prototype of the secondary class to be updated in the tuple set, and updating the historical prototype corresponding to the secondary class to be updated and the historical distribution density in the tuple set according to the prototype to be updated and historical prototype corresponding to the secondary class to be updated and the distribution density of text data.

Specifically, the historical prototype of the secondary class to be updated in the tuple set may be updated by using the weighted average of the prototype to be updated and historical prototype corresponding to the secondary class to be updated. The historical distribution density corresponding to the target secondary text class in the tuple set may be updated by directly using the determined distribution density of text data of the target secondary text class.

This process may focus on the following three operations.

(1) Determining whether it is necessary to newly add a prototype (of a secondary text class) and its distribution density after the user newly adds a text to a (primary) text class.

(2) How to newly add a prototype and its density. If it is determined in the first step that it is necessary to newly add a prototype, the prototype is calculated according to the newly added text, and the data distribution density of the corresponding secondary text class is estimated by the online density estimation module described above.

(3) How to reason during classification after the prototype and density are newly added. The topics are visible to the model. Therefore, when a new text is to be classified, firstly determine which topic this text belongs to, then obtaining its class by table lookup.

In short, the framework flow of the multi-prototype (multi-density) mechanism according to an embodiment of the present disclosure is shown in FIG. 14 and partially overlapped with the flow shown in FIG. 5, and also includes two parts, i.e., online training and online inference. The online training mainly differs from FIG. 5 in the fifth operation. The online training mainly includes the following operations.

(1) The user inputs text data, for example, a new primary text class and text data added to this text class by the user, or text data newly added to an existing primary text class by the user, or the like.

(2) The input text data is coded and represented by a certain text representation algorithm; and, feature extraction is performed on the coded representation by a feature engineering and the obtained original feature vector is mapped to the target space. Or, the input text may also be directly converted into a feature vector in the target space by CNN or other technologies.

(3) The prototype points position μ_{class} (i.e., the weighted average of vectors after these texts are mapped to the target space) of the target class in the target space is calculated based on a number of text data input by the user.

(4) Based on the multi-prototype determination module, it is determined whether it is necessary to newly add a prototype and its distribution density (corresponding to a secondary text class) for this primary text class. If it is unnecessary to newly add a prototype and its density, the secondary text class to be updated corresponding to this sample is determined, and a prototype μ_{class} is calculated; and, the distribution density information σ_{T} of the corresponding topic (secondary text class) is determined. If it is necessary to newly add a prototype and its density, a new topic is added to the mapping table described above and associated with the corresponding primary text class, the newly added prototype μ_{topic} is calculated according to this sample, and the distribution density information σ_{T} of the newly added topic (secondary text class) is determined based on the online density estimation module.

(5) The tuple (prototype and distribution density) after newly adding/updating the topic is added to the model. The model contains the prototypes and data distribution densities of all topics (secondary text classes) of all existing text classes (primary), which will be used for the online inference process.

The online inference is basically the same as the flow shown in FIG. 5. However, the tags for inference represent different text topics (secondary text classes) under text classes, rather than text classes (primary text class), a table lookup operation is required in the last step. The online inference process includes the following operations.

(1) A text (Text, ?) is acquired. The text may be a new text input by the user or a new text received by the user. For example, the user adds a short text to the note app of the mobile phone, or the user newly receives a short message.

(2) The text is coded and represented by a text representation module; and, the coded representation of the text is subjected to feature extraction by feature engineering and then mapped to the target space. Or, the text may be directly converted into a feature vector in the target space by CNN or other technologies, such that the feature representation μᵢₙₚᵤₜ of the text may be obtained.

(3) Inference and probability calculation are performed on the text according to the set (μ,) of each secondary text class by a prototype and density metric learning algorithm, and the text is then processed by a softmax layer.

(4) If the tag output by inference is a certain text topic (secondary text class), the text class (primary text class) corresponding to this topic is searched by looking up the mapping table and finally output.

In the embodiment of the present disclosure, the improvement by the multi-prototype determination module labeled with \textcircled{3} in the framework shown in FIG. 14 is described.

In one feasible implement, the determining according to the text feature of this target text and the tuple set whether there is a newly added secondary text class in the target text class may include determining, according to the text feature of this target text and the tuple set of each target secondary text class in the target text class, a similarity between the secondary text class corresponding to this target text and each target secondary text class, determining, according to the text feature of this target text and the tuple set of each other secondary text class in other text classes except for the target text class in the tuple set, a similarity between the secondary text class corresponding to this target text and each other secondary text class, and based on the similarity between the secondary text class corresponding to this target text and each target secondary text class and the similarity between the secondary text class corresponding to this target text and each other secondary text class, determining whether there is a newly added secondary text class in the target text class.

Specifically, if the secondary text class corresponding to this target text has the highest similarity with a certain target secondary text class, it is unnecessary to newly add a secondary text class, and it is only necessary to determine the target secondary text class having the highest similarity as a secondary text class to be updated and execute the operation of updating the corresponding prototype and distribution density. If the secondary text class corresponding to the target text has the highest similarity with a certain other secondary text class, it is necessary to newly add the secondary text class to the target text class. In brief, if the new input text cannot be classified well by using the prototype set and distribution density of the current primary text class (the new input text is classified into other text classes by mistake but not classified into its own text class), it is possible to newly add a prototype and its density estimation.

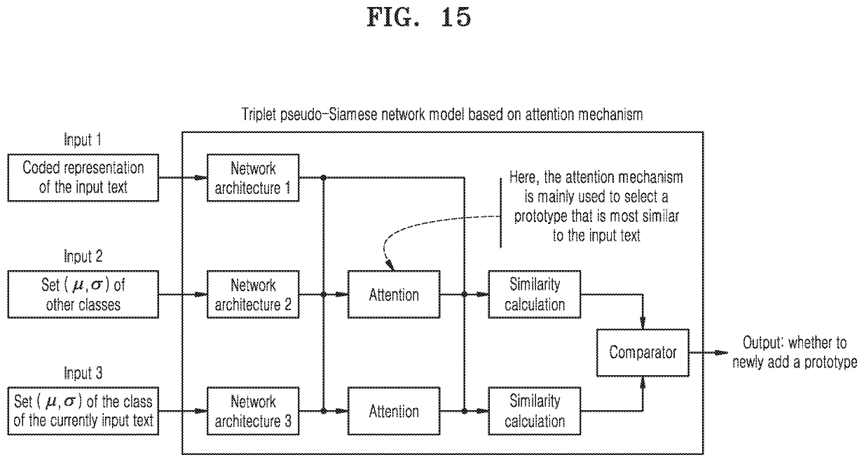

FIG. 15 is a diagram of a triplet pseudo-Siamese Network model according to an embodiment. In the embodiment of the present disclosure, during determining whether it is necessary to newly add a prototype and its distribution density, the above process may be executed by the triplet pseudo-Siamese Network model according to the embodiment of the present disclosure. As shown in FIG. 15, the triplet pseudo-Siamese Network model mainly includes three modules.

(1) The first module (network architecture 1 and network architecture 2) performs feature engineering on the input, that is, performing feature conversion on the input by a hidden layer of the neural network. Since there are two types of inputs, i.e., the newly added text feature and the existing tuple set, the inputs correspond to two different hidden layers of the neural network (that is, in FIG. 15, input 1 corresponds to one hidden layer of the neural network, and inputs 2 and 3 correspond to the same other hidden layer of the neural network). Therefore, the algorithm is a pseudo-Siamese Network (in a Siamese Network, all inputs share the same hidden layer of the neural network.

(2) The second module is an attention layer for screening core features, i.e., screening a prototype that is most similar to the input text.

(3) The third module is a similarity calculation module that can perform calculation by some simple similarity calculation methods and neural networks.

Specifically, for a new input text, a probability that this text belongs to its (primary) text class (input 1 and 3 in FIG. 15) (i.e., the similarity between this text and the prototype and distribution density of each secondary class in its primary text class) and the extreme value for the similarity between this text and other text classes (input 1 and 2 in FIG. 15) are determined. Then, the two similarities are compared by a comparator to determine whether the input requires a Boolean value (one of “True” or “False”) indicating the newly added prototype and its distribution density.

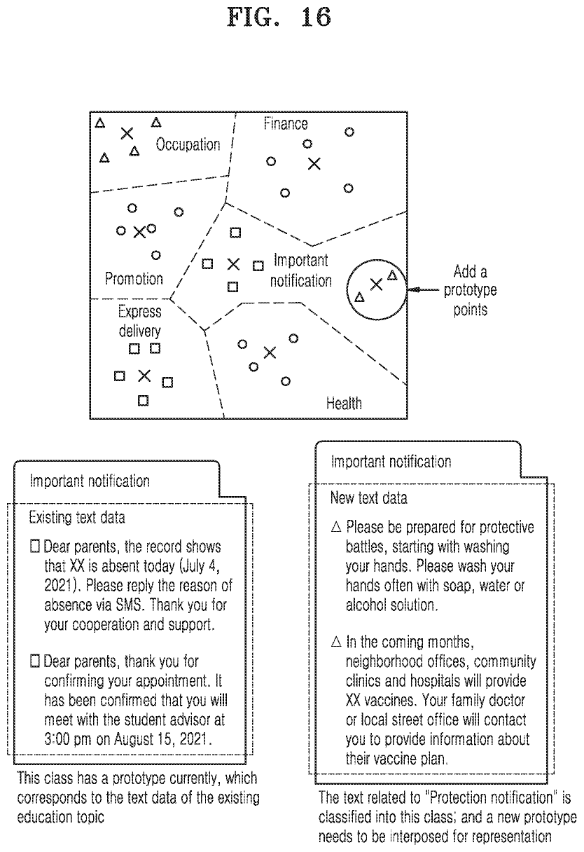

FIG. 16 is a diagram of another example of short message classification according to an embodiment. FIG. 16 shows a practical example of short message classification. The user-defined text classes include Occupation, Finance, Promotion, Express delivery, Health, Important notification or the like. In the initial stage, the class Important Notification contains only parenting-related notification short messages (that is, this text class has only one prototype currently). Subsequently, the user puts two short messages about protection notification and vaccination into this text class. Since protection notification and parenting belong to two entirely different topics, and the two short messages will be most possibly classified into other text classes (e.g., class Health) during classification if the text class tag added by the user is ignored, it is necessary to newly add a prototype and its distribution density to the class Important Notification to represent the newly added text topic. It will be understood that, the text shown in FIG. 16 is merely schematic, and the solution of the present disclosure does not focus on the specific text content and type. That is, the specific content and specific type of the text does not affect the implementation of the solution of the present disclosure.

In the multi-prototype (multi-density) mechanism based on the triplet pseudo-Siamese Network according to the embodiment of the present disclosure, whether to newly add a prototype is determined by determining the classification performed of the prototype and distribution density of each topic in each text class currently on the new points. In other words, in the process of determining whether to newly add a prototype, the absorptive capability of the text class of the new text for this points (whether this points may be absorbed as its own points) may be taken into consideration, and the strength of other text classes to absorb this points as their own points may also be taken into consideration. This determination process is actually a gaming process. By introducing the absorptive strength of other text classes for the new points, which points being a key points that is easy to be incorrectly classified may be better distinguished, such that the topic more matched with the new points may be effectively identified, and it may be determined whether to newly establish a prototype. By newly establishing a prototype to strengthen of the classification of the points, this points and the potential similar points are avoided from being incorrectly classified.

In the text classification method according to the embodiment of the present disclosure, it is unnecessary to store the historical text data of each text class, so it is greatly beneficial for the user's personal information protection, privacy protection, data security guarantee or the like, and it is helpful to reduce the storage of the mobile device.

In the text classification method according to the embodiment of the present disclosure, the distribution density of the support data is introduced into each module in the text classification, such that the influence of the distribution of the support data in the text classification is fully exerted.

Specifically, by introducing the distribution density of support data of the existing text classes into the metric learning, the distribution of data in each text class is effectively measured. In addition, by introducing hypothesis testing into the classification module, the classification problem becomes a statistical hypothesis testing problem. In practical applications, a prototype network model based on prototype and density may be constructed on this basis to execute these methods.

Further, an online data distribution density estimation module is proposed, which can effectively estimate the distribution density of support samples in real time in the case of only one or few samples.

Furthermore, a multi-prototype mechanism based on a triplet pseudo-Siamese Network is proposed, which can estimate the classification performance of the new input text may be estimated by using the prototype and distribution density of each text class currently, and determines whether to newly add a prototype and its distribution density, thereby ensuring a more reliable training result.

By the above modules, in the embodiment of the present disclosure, a text may be classified using small data based on two factors, i.e., prototype and distribution density, thereby improving the efficiency and accuracy of classification.

The text classification method according to an embodiment of the present disclosure has the following advantages:

(1) accurate classification: the text is classified into one of predefined text classes;

(2) personalization: it supports that different users can have different sets of text classes;

(3) adaptability: it supports that the user adds or alters text classes according to his/her preferences;

(4) interactivity: it learns the interaction with the user and quickly reflects the reaction in the model;

(5) scalability: it continuously learns new input text classes.

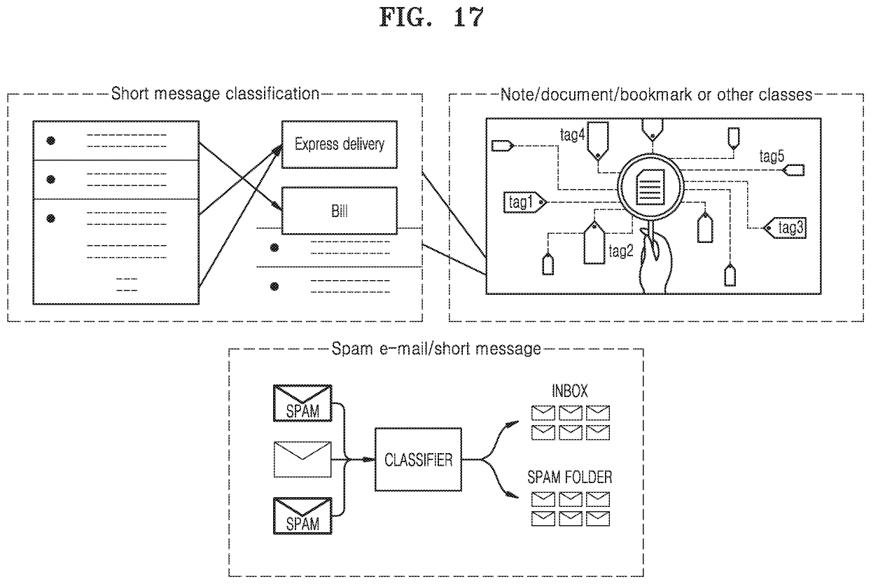

FIG. 17 is a diagram of an application scenario according to an embodiment. The text classification method according to the embodiment of the present disclosure may be applied in application scenarios on the mobile device side shown in FIG. 17, particularly mobile phones, including but not limited to, classification of short messages, notes, files (e.g., documents), browser bookmarks, screenshots or the like, detection of spam short messages/spam e-mails, or the like. By the text classification according to the embodiment of the present disclosure, unstructured texts may be grouped, such that it is beneficial to manage files, and subsequent quick retrieval services may be provided, thereby improving the user experience.

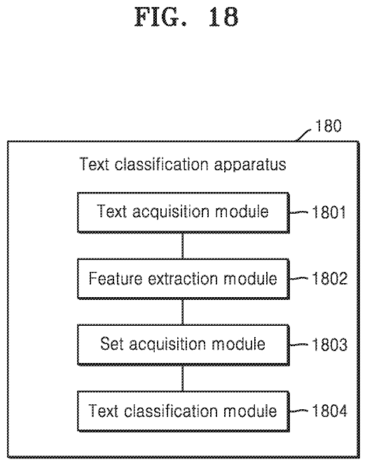

FIG. 18 is a schematic structure diagram of a text classification apparatus according to an embodiment of the present disclosure. An embodiment of the present disclosure provides a text classification apparatus. As shown in FIG. 18, the text classification apparatus 180 may include: a text acquisition module 1801, a feature extraction module 1802, a set acquisition module 1803 and a text classification module 1804, where, the text acquisition module 1801 is configured to acquire a text to be classified, the feature extraction module 1802 is configured to perform feature extraction on the text to be classified to obtain a feature representation of the text to be classified, the set acquisition module 1803 is configured to acquire a tuple set of each current text class, the tuple set of each text class including the prototype of this text class and the distribution density of text data of this text class, and the text classification module 1804 is configured to classify the text to be classified based on the feature representation of the text to be classified and the tuple set to obtain a text class of the text to be classified.

In an embodiment, the text classification apparatus 180 may further include a training module, before the set acquisition module 1803 is configured to acquire a tuple set of each current text class, the training module is configured to, based on an editing operation for a text class being received, execute the following process to obtain a tuple set: acquiring a target text class corresponding to the editing operation and at least one target text corresponding to the editing operation, performing feature extraction on the at least one target text to obtain a feature representation corresponding to the at least one target text, respectively, determining a prototype to be updated of the target text class based on the feature representation corresponding to the at least one target text, determining the distribution density of text data of the target text class based on the text feature of the at least one target text and the prototype to be updated, and updating the prototype to be updated and the distribution density of text data of the target text class into the tuple set.

In an embodiment, when the training module is configured to determine a prototype to be updated of the target text class based on the feature representation corresponding to the at least one target text, it is specifically configured to perform weighted averaging on the feature representation corresponding to the at least one target text to obtain a prototype to be updated of the target text class.

In an embodiment, when the training module is configured to update the prototype to be updated and the distribution density of text data of the target text class into the tuple set, it is specifically configured to, if the target text class corresponding to the editing operation is a newly added text class, use the prototype to be updated as the prototype of the target text class, and add the prototype to be updated and the distribution density of text data of the target text class into the tuple set, and if the target text class corresponding to the editing operation is not a newly added text class, acquire a historical prototype of the target text type in the tuple set, and update the historical prototype in the tuple set and the historical distribution density corresponding to the target text class according to the prototype to be updated, the historical prototype and the distribution density of text data of the target text class.

In an embodiment, when the text classification module 1804 is configured to classify the text to be classified based on the feature representation of the text to be classified and the tuple set, it is specifically configured to use the feature representation of the text to be classified as a center of a Gaussian distribution, determine a probability that the text data of each text class is sampled from the Gaussian distribution, and, classify the text to be classified based on each determined probability.

In an embodiment, when the text classification module 1804 is configured to determine a probability that the text data of each text class is sampled from the Gaussian distribution, it is specifically configured to for each text class, determine, according to the number of text data of this text class, the tuple set of this text class and the feature representation of the text to be classified, the hypothesis testing statistic of the text data of this text class sampled from the Gaussian distribution, and determine the probability corresponding to the each text class according to the hypothesis testing statistic corresponding to the each text class.

In an embodiment, when the training module is configured to determine the distribution density of text data of the target text class based on the text feature of the at least one target text and the prototype to be updated, it is specifically configured to perform time-sequence feature extraction on the text feature of the at least one target text by a first LSTM network to obtain a text feature containing time-sequence information of the at least one target text, and determine the distribution density of text data of the target text class based on the text feature containing time-sequence information of the at least one target text and the prototype to be updated.

In an embodiment, when the training module is configured to determine the distribution density of text data of the target text class based on the text feature of the at least one target text and the prototype to be updated, it is specifically configured to determine, according to the prototype to be updated and a tuple set of each external text class and from external text classes, a similar text class having a similarity with the target text class being greater than a threshold, the external text classes being text classes except for the target text class among the text classes corresponding to the tuple set, acquire a tuple of the similar text class, and determine the distribution density of text data of the target text class based on the text feature of the at least one target text and the tuple of the similar text class.

In an embodiment, when the training module is configured to determine the distribution density of text data of the target text class based on the text feature of the at least one target text and the tuple of the similar text class, it is specifically configured to perform time-sequence feature extraction on the text feature of the at least one target text and the tuple of the similar text class by a second LSTM network, and allocate weight information of the target text class and the similar text class to obtain the distribution density of text data of the target text class.

In an embodiment, the tuple set of each text class is a tuple set of each secondary text class.

In an embodiment, when the text classification module 1804 is configured to obtain a text class of the text to be classified, it is specifically configured to obtain a secondary text class of the text to be classified.

In an embodiment, after the text classification module 1804 is configured to obtain a secondary text class of the text to be classified, it is further configured to determine a primary text class of the text to be classified according to the preset mapping table between primary text classes and secondary text classes and the secondary text class of the text to be classified.

In an embodiment, the editing operation for a text class is an editing operation for a primary text class.

In an embodiment, when the training module is configured to, for each target text in the at least one target text, determine the distribution density of text data of the target text class based on the text feature of this target text and the prototype to be updated, it is specifically configured to determine according to the text feature of this target text and the tuple set whether there is a newly added secondary text class in the target text class, if there is a newly added secondary text class in the target text class, update the mapping table between primary text classes and secondary text classes according to the target text class and the newly added secondary text class, and determine the distribution density of text data of the newly added secondary text class based on the text feature of this target text and the prototype of the newly added secondary text class, and if there is no newly added secondary text class in the target text class, determine a secondary text class to be updated corresponding to this target text, and determine the distribution density of text data of the secondary text class to be updated based on the text feature of this target text and prototype to be updated of the secondary text class to be updated.

In an embodiment, when the training module is configured to update the prototype to be updated and the distribution density of text data of the target text class into the tuple set, it is specifically configured to execute at least one of the following: adding the prototype corresponding to the newly added secondary text class and the distribution density of text data into the tuple set, and acquiring a historical prototype of the secondary class to be updated in the tuple set, and updating the historical prototype corresponding to the secondary class to be updated and the historical distribution density in the tuple set according to the prototype to be updated and historical prototype corresponding to the secondary class to be updated and the distribution density of text data.

In an embodiment, when the training module is configured to determine according to the text feature of this target text and the tuple set whether there is a newly added secondary text class in the target text class, it is specifically configured to determine, according to the text feature of this target text and the tuple set of each target secondary text class in the target text class, a similarity between the secondary text class corresponding to this target text and each target secondary text class, determine, according to the text feature of this target text and the tuple set of each other secondary text class in other text classes except for the target text class in the tuple set, a similarity between the secondary text class corresponding to this target text and each other secondary text class, and based on the similarity between the secondary text class corresponding to this target text and each target secondary text class and the similarity between the secondary text class corresponding to this target text and each other secondary text class, determine whether there is a newly added secondary text class in the target text class.

For the apparatus according to the embodiment of the present disclosure, at least one of multiple modules may be realized by an artificial intelligence (AI) model. The functions associated with AI may be executed by a non-volatile memory, a volatile memory and a processor.

The processor may include one or more processors. At this time, the one or more processor may be general-purpose processors (e.g., central processing units (CPUs), application processors (APs), etc.), or pure graphics processing units (e.g., a graphics processing units (GPUs), visual processing units (VPUs)), and/or AI-specific processors (e.g., neural processing units (NPUs)).

The one or more processors control the processing of the input data according to the predefined operation rule or AI model stored in the non-volatile memory and the volatile memory. The predefined operation rule or AI model is provided by training or learning.

Here, providing by learning means that the predefined operation rule or AI model with desired characteristics is obtained by applying a learning algorithm to multiple pieces of learning data. The learning may be executed in a device in which the AI according to the embodiments is executed, and/or may be implemented by a separate server/system.

The AI model may include multiple neural network layers. Each layer has multiple weights, and the calculation in one layer is executed by using the result of calculation in the previous layer and multiple weights of the current layer. Examples of the neural network include, but not limited to: CNNs, deep neural networks (DNNs), Recurrent neural network (RNNs), restricted Boltzmann machines (RBMs), deep belief networks (DBNs), bidirectional Recurrent neural network (BRNNs), generative adversarial network (GANs) and deep Q networks.

The learning algorithm is a method of training a predetermined target apparatus (e.g., a robot) by using multiple pieces of learning data to enable, allow or control the target apparatus to determine or predict. Examples of the learning algorithm include, but not limited to: supervised learning, semi-supervised learning or reinforced learning.

The apparatus according to the embodiment of the present disclosure can execute the methods according to the embodiments of the present disclosure, and the implementation principles thereof are similar. The acts executed by the modules in the apparatus according to the embodiment of the present disclosure correspond to the steps in the methods according to the embodiments of the present disclosure. The detailed functional description of the modules in the apparatus can refer to the description of the corresponding methods described above and will not be repeated here.

An embodiment of the present disclosure provides an electronic device, including a memory, a processor and computer programs stored on the memory, where the processor executes the computer programs to implement the steps in the method embodiments described above.

In the embodiment of the present disclosure, when the method embodiments are executed in the electronic device, the method for inference and predicting text classification can use an AI model to execute the classification of the text to be classified by using the prototype and data distribution density of each text class. The processor can pre-process the data to convert the data into a form suitable for the input of the AI model. The AI model may be obtained by training. Here, “obtaining by training” means that the basic AI model is trained by multiple pieces of training data through a training algorithm to obtain a predefined operation rule or AI model configured to execute desired features (or objectives). The AI model may include multiple neural network layers. Each of the multiple neural network layers includes multiple weight values, and neural network calculation is executed by calculating the result of calculation of the previous layer and the multiple weight values.

Inference prediction is a technology of logic inference and prediction by determining information, for example, including knowledge-based inference, optimized prediction, preference-based prediction or recommendation.

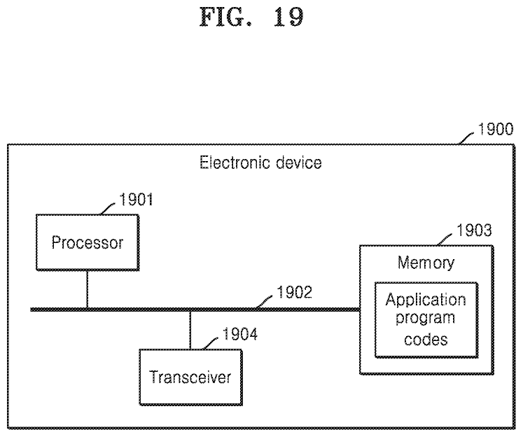

FIG. 19 is a schematic structure diagram of an electronic device according to an embodiment of the present disclosure. In one optional embodiment, an electronic device is provided, as shown in FIG. 19. The electronic device 1900 shown in FIG. 19 includes a processor 1901 and a memory 1903. The processor 1901 is connected to the memory 1903, for example, via a bus 1902. Optionally, the electronic device 1900 may further include a transceiver 1904. The transceiver 1904 may be configured for data interaction between the electronic device and other electronic devices, for example, transmitting data and/or receiving data, or the like. It is to be noted that, in practical applications, the number of the transceiver 1904 is not limited to 1, and the structure of the electronic device 1900 does not constitute any limitations to the embodiments of the present disclosure.

The processor 1901 may be a CPU, a general-purpose processor, a digital signal processor (DSP), an application specific integrated circuit (ASIC), a field programmable gate array (FPGA) or other programmable logic devices, a transistor logic device, a hardware component or any combination thereof. The processor can implement or execute various exemplary logic blocks, modules and circuits described in the disclosure of the present disclosure. The processor 1901 may also be a combination for realizing a computing function, for example, a combination of one or more microprocessors, a combination of DSPs and microprocessors, or the like.

The bus 1902 may include a passageway for transferring information between the above components. The bus 1902 may be a peripheral component interconnect (PCI) bus, an extended industry standard architecture (EISA) bus, or the like. The bus 1902 may be classified into address bus, data bus, control bus or the like. For ease of representation, the bus is represented by only one bold line in FIG. 19, but it does not mean that there is only one bus or one type of buses.

The memory 1903 may be, but not limited to, a read only memory (ROM) or other types of static storage devices capable of storing static information and instructions, a random access memory (RAM) or other types of dynamic storage devices capable of storing information and instructions, or an electrically erasable programmable read only memory (EEPROM), compact disc read only memory (CD-ROM) or other optical disc storages, optical disc storages (including compact disc, laser disc, optical disc, digital versatile optical disc, Blu-ray disc, etc.), magnetic disc storage mediums or other magnetic storage devices, or any other medium that may be used to carry or store computer programs and may be accessed by a computer.

The memory 1903 is configured to store compute programs for executing the embodiments of the present disclosure and is controlled by the processor 1901. The processor 1901 is configured to execute the computer programs stored in the memory 1903 to implement the steps in the above method embodiments.

An embodiment of the present disclosure provides a computer-readable storage medium having computer programs stored thereon that, when executed by a processor, can implement the steps and corresponding contents in the above method embodiments.

An embodiment of the present disclosure further provides a computer program product, including computer programs that, when executed by a processor, can implement the steps and corresponding contents in the above method embodiments.

It will be understood that, although the operation steps are indicated by arrows in the flowcharts of the embodiments of the present disclosure, the implementation order of these steps is not limited to the order indicated by the arrows. Unless explicitly stated herein, in some implementation scenarios of the embodiments of the present disclosure, the implementation steps in the flowcharts may be executed in other orders as required. In addition, depending on practical implementation scenarios, some or all of the steps in the flowcharts may include multiple sub-steps or multiple stages. Some or all of these sub-steps or stages may be executed at the same moment, and each of these sub-steps or stages may be separately executed at different moments. When each of these sub-steps or stages is executed at different moments, the execution order of these sub-steps or stages may be flexibly configured as required, and will not be limited in the embodiments of the present disclosure.

At least one of the components, elements, modules or units (collectively “components” in this paragraph) represented by a block in the drawings including, but not limited to, FIGS. 4, 7, 8, 9, 10, 12, 14, 15, 18 and 19, may be embodied as various numbers of hardware, software and/or firmware structures that execute respective functions described above, according to an example embodiment. According to example embodiments, at least one of these components may use a direct circuit structure, such as a memory, a processor, a logic circuit, a look-up table, etc. that may execute the respective functions through controls of one or more microprocessors or other control apparatuses. Also, at least one of these components may be specifically embodied by a module, a program, or a part of code, which contains one or more executable instructions for performing specified logic functions, and executed by one or more microprocessors or other control apparatuses. Further, at least one of these components may include or may be implemented by a processor such as a central processing unit (CPU) that performs the respective functions, a microprocessor, or the like. Two or more of these components may be combined into one single component which performs all operations or functions of the combined two or more components. Also, at least part of functions of at least one of these components may be performed by another of these components. Functional aspects of the above example embodiments may be implemented in algorithms that execute on one or more processors. Furthermore, the components represented by a block or processing steps may employ any number of related art techniques for electronics configuration, signal processing and/or control, data processing and the like.

According to an aspect of the disclosure, a text classification method may include acquiring a text to be classified. A text classification method may include obtaining a feature representation of the text to be classified by performing feature extraction on the text to be classified. A text classification method may include acquiring a tuple set of each current text class, the tuple set of each text class including a prototype of each respective text class and a distribution density of text data of each respective text class. A text classification method may include obtaining a text class of the text to be classified by classifying the text to be classified based on the feature representation of the text to be classified and the tuple set.

A text classification method may further comprise, prior to the acquiring the tuple set of each current text class, based on an editing operation for a text class being received, acquiring a target text class corresponding to the editing operation and at least one target text corresponding to the editing operation, obtaining a feature representation corresponding to the at least one target text by performing feature extraction on the at least one target text, determining a prototype to be updated of the target text class based on the feature representation corresponding to the at least one target text, determining a distribution density of text data of the target text class based on a text feature of the at least one target text and the prototype to be updated and updating the prototype to be updated and the distribution density of text data of the target text class into the tuple set.

The determining the prototype to be updated comprises performing weighted averaging on the feature representation corresponding to the at least one target text.

The updating the prototype to be updated and the distribution density of text data of the target text class comprises based on the target text class corresponding to the editing operation being a newly added text class, using the prototype to be updated as the prototype of the target text class, and adding the prototype to be updated and the distribution density of text data of the target text class into the tuple set and based on the target text class corresponding to the editing operation not being a newly added text class, acquiring a historical prototype of a target text type in the tuple set, and updating the historical prototype in the tuple set and a historical distribution density corresponding to the target text class according to the prototype to be updated, the historical prototype and the distribution density of text data of the target text class.

The classifying the text to be classified comprises using the feature representation of the text to be classified as a center of a Gaussian distribution, determining a probability that text data of each text class is sampled from the Gaussian distribution and classifying the text to be classified based on each determined probability.

The determining the probability that the text data of each text class is sampled from the Gaussian distribution comprises for each text class, determining a hypothesis testing statistic of the text data of each text class sampled from the Gaussian distribution, based on a number of text data of the text class, the tuple set of this text class and the feature representation of the text to be classified and determining the probability corresponding to each text class based on the hypothesis testing statistic corresponding to each text class.

The determining the distribution density of text data of the target text class comprises obtaining a text feature containing time-sequence information of the at least one target text by performing time-sequence feature extraction on the text feature of the at least one target text by a first long short-term memory (LSTM) network and determining the distribution density of text data of the target text class based on the text feature containing time-sequence information of the at least one target text and the prototype to be updated.

The determining the distribution density of text data of the target text class comprises determining at least one text class that has a similarity value above a threshold from external text classes, based on the prototype to be updated and a tuple set of each external text class, the external text classes being text classes other than the target text class among the text classes corresponding to the tuple set of each current text class, acquiring a tuple of a similar text class and determining the distribution density of text data of the target text class based on a text feature of the at least one target text and the tuple of the similar text class.

The determining the distribution density of text data of the target text class further comprises performing time-sequence feature extraction on the text feature of the at least one target text and the tuple of the similar text class by a second long short-term memory (LSTM) network, and allocating weight information of the target text class and the similar text class to obtain the distribution density of text data of the target text class.

The tuple set of each text class comprises a tuple set of each secondary text class.

The obtaining the text class of the text to be classified comprises obtaining a secondary text class of the text to be classified.

After obtaining the text class of the text to be classified, the text classification method further comprises determining a primary text class of the text to be classified based on both a preset mapping table between primary text classes and secondary text classes and the secondary text class of the text to be classified.

The editing operation for a text class comprises an editing operation for a primary text class.

For each target text in the at least one target text, determining the distribution density of text data of the target text class based on a text feature of each target text and the prototype to be updated, the method further comprises determining, based on the text feature of each target text and the tuple set, whether a new secondary text class is to be inserted in the target text class, based on determining that the new secondary text class is to be inserted in the target text class, updating a mapping table between primary text classes and secondary text classes based on the target text class and the new secondary text class, and determining a distribution density of text data of the new secondary text class based on the text feature of each target text and a prototype of the new secondary text class and based on determining that no new secondary text class is to be inserted in the target text class, determining a secondary text class to be updated corresponding to each target text, and determining the distribution density of text data of the secondary text class to be updated based on the text feature of the target text and the prototype to be updated of the secondary text class to be updated.

The updating the prototype to be updated and the distribution density of text data of the target text class into the tuple set comprises at least one adding the prototype corresponding to the new secondary text class and the distribution density of text data into the tuple set, acquiring a historical prototype of the secondary text class to be updated in the tuple set and updating the historical prototype corresponding to the secondary text class to be updated and a historical distribution density in the tuple set based on the prototype to be updated, the historical prototype corresponding to the secondary text class to be updated and the distribution density of text data.

The determining whether the new secondary text class is to be inserted in the target text class comprises determining, based on the text feature of each target text and the tuple set of each target secondary text class in the target text class, a similarity between the secondary text class corresponding to the target text and each target secondary text class, determining, based on the text feature of each target text and the tuple set of each other secondary text class in other primary text classes except the target text class in the tuple set, a similarity between the secondary text class corresponding to the target text and each other secondary text class and based on the similarity between the secondary text class corresponding to the target text and each target secondary text class and the similarity between the secondary text class corresponding to the target text and each other secondary text class, determining whether the new secondary text class is to be inserted in the target text class.

According to an aspect of the disclosure, a text classification apparatus may include a text acquisition module configured to acquire a text to be classified. A text classification apparatus may include a feature extraction module configured to obtain a feature representation of the text to be classified by performing feature extraction on the text to be classified. A text classification apparatus may include a set acquisition module configured to acquire a tuple set of each current text class, the tuple set of each text class including a prototype of each respective text class and a distribution density of text data of each respective text class. A text classification apparatus may include a text classification module configured to obtain a text class of the text to be classified by classifying the text to be classified based on the feature representation of the text to be classified and the tuple set.

According to an aspect of the disclosure, a non-transitory computer-readable storage medium may store instructions that, when executed by a processor, cause the processor to acquire a text to be classified. a non-transitory computer-readable storage medium may store instructions that, when executed by a processor, cause the processor to obtain a feature representation of the text to be classified by performing feature extraction on the text to be classified. A non-transitory computer-readable storage medium may store instructions that, when executed by a processor, cause the processor to acquire a tuple set of each current text class, the tuple set of each text class including a prototype of each respective text class and a distribution density of text data of each respective text class. A non-transitory computer-readable storage medium may store instructions that, when executed by a processor, cause the processor to obtain a text class of the text to be classified by classifying the text to be classified based on the feature representation of the text to be classified and the tuple set.

The instructions, when executed, further cause the processor to, prior to acquiring the tuple set of each current text class and based on an editing operation for a text class being received acquire a target text class corresponding to the editing operation and at least one target text corresponding to the editing operation, obtain a feature representation corresponding to the at least one target text by performing feature extraction on the at least one target text, determine a prototype to be updated of the target text class based on the feature representation corresponding to the at least one target text, determine a distribution density of text data of the target text class based on a text feature of the at least one target text and the prototype to be updated and update the prototype to be updated and the distribution density of text data of the target text class into the tuple set

An electronic device, comprising a memory, a processor and computer programs stored on the memory, wherein the processor executes the computer programs to implement the steps in the text classification method.

A computer program product, comprising computer programs that, when executed by a processor, implement the steps in the text classification method.

The foregoing description merely shows the optional implementations of some implementation scenarios of the present disclosure. For a person of ordinary skill in the art, without departing from the technical ideal of the solutions of the present disclosure, other similar implementation means based on the technical idea of the present disclosure shall also fall into the protection scope of the embodiments of the present disclosure.

What is claimed is:

1. A text classification method, comprising:
acquiring a text to be classified;
obtaining a feature representation of the text to be classified by performing feature extraction on the text to be classified;
acquiring a tuple set of each current text class, the tuple set of each text class comprising a prototype of each respective text class and a distribution density of text data of each respective text class; and
obtaining a text class of the text to be classified by classifying the text to be classified based on the feature representation of the text to be classified and the tuple set.

2. The text classification method of claim 1, further comprising, prior to the acquiring the tuple set of each current text class:
based on an editing operation for a text class being received:
acquiring a target text class corresponding to the editing operation and at least one target text corresponding to the editing operation;
obtaining a feature representation corresponding to the at least one target text by performing feature extraction on the at least one target text;
determining a prototype to be updated of the target text class based on the feature representation corresponding to the at least one target text;
determining a distribution density of text data of the target text class based on a text feature of the at least one target text and the prototype to be updated; and
updating the prototype to be updated and the distribution density of text data of the target text class into the tuple set.

3. The text classification method of claim 2, wherein the determining the prototype to be updated comprises:
performing weighted averaging on the feature representation corresponding to the at least one target text.

4. The text classification method of claim 2, wherein the updating the prototype to be updated and the distribution density of text data of the target text class comprises:
based on the target text class corresponding to the editing operation being a newly added text class, using the prototype to be updated as the prototype of the target text class, and adding the prototype to be updated and the distribution density of text data of the target text class into the tuple set; and
based on the target text class corresponding to the editing operation not being a newly added text class, acquiring a historical prototype of a target text type in the tuple set, and updating the historical prototype in the tuple set and a historical distribution density corresponding to the target text class according to the prototype to be updated, the historical prototype and the distribution density of text data of the target text class.

5. The text classification method of claim 4, wherein the classifying the text to be classified comprises:
using the feature representation of the text to be classified as a center of a Gaussian distribution;
determining a probability that text data of each text class is sampled from the Gaussian distribution; and
classifying the text to be classified based on each determined probability.

6. The text classification method of claim 5, wherein the determining the probability that the text data of each text class is sampled from the Gaussian distribution comprises:
for each text class, determining a hypothesis testing statistic of the text data of each text class sampled from the Gaussian distribution, based on a number of text data of the text class, the tuple set of this text class and the feature representation of the text to be classified; and
determining the probability corresponding to each text class based on the hypothesis testing statistic corresponding to each text class.

7. The text classification method of claim 2, wherein the determining the distribution density of text data of the target text class comprises:
obtaining a text feature containing time-sequence information of the at least one target text by performing time-sequence feature extraction on the text feature of the at least one target text by a first long short-term memory (LSTM) network; and
determining the distribution density of text data of the target text class based on the text feature containing time-sequence information of the at least one target text and the prototype to be updated.

8. The text classification method of claim 2, wherein the determining the distribution density of text data of the target text class comprises:
determining at least one text class that has a similarity value above a threshold from external text classes, based on the prototype to be updated and a tuple set of each external text class, the external text classes being text classes other than the target text class among the text classes corresponding to the tuple set of each current text class;
acquiring a tuple of a similar text class; and
determining the distribution density of text data of the target text class based on a text feature of the at least one target text and the tuple of the similar text class.

9. The text classification method of claim 8, wherein the determining the distribution density of text data of the target text class further comprises:
performing time-sequence feature extraction on the text feature of the at least one target text and the tuple of the similar text class by a second long short-term memory (LSTM) network, and
allocating weight information of the target text class and the similar text class to obtain the distribution density of text data of the target text class.

10. The text classification method claim 2, wherein the tuple set of each text class comprises a tuple set of each secondary text class;
wherein obtaining the text class of the text to be classified comprises:
obtaining a secondary text class of the text to be classified; and
wherein, after obtaining the text class of the text to be classified, the text classification method further comprises:
determining a primary text class of the text to be classified based on both a preset mapping table between primary text classes and secondary text classes and the secondary text class of the text to be classified.

11. The text classification method of claim 2, wherein the editing operation for a text class comprises an editing operation for a primary text class;
wherein, for each target text in the at least one target text, determining the distribution density of text data of the target text class based on a text feature of each target text and the prototype to be updated, the method further comprises:
determining, based on the text feature of each target text and the tuple set, whether a new secondary text class is to be inserted in the target text class;
based on determining that the new secondary text class is to be inserted in the target text class, updating a mapping table between primary text classes and secondary text classes based on the target text class and the new secondary text class, and determining a distribution density of text data of the new secondary text class based on the text feature of each target text and a prototype of the new secondary text class; and
based on determining that no new secondary text class is to be inserted in the target text class, determining a secondary text class to be updated corresponding to each target text, and determining the distribution density of text data of the secondary text class to be updated based on the text feature of the target text and the prototype to be updated of the secondary text class to be updated, and
wherein updating the prototype to be updated and the distribution density of text data of the target text class into the tuple set comprises at least one:
adding the prototype corresponding to the new secondary text class and the distribution density of text data into the tuple set;
acquiring a historical prototype of the secondary text class to be updated in the tuple set; and
updating the historical prototype corresponding to the secondary text class to be updated and a historical distribution density in the tuple set based on the prototype to be updated, the historical prototype corresponding to the secondary text class to be updated and the distribution density of text data.

12. The text classification method of claim 11, wherein the determining whether the new secondary text class is to be inserted in the target text class comprises:
determining, based on the text feature of each target text and the tuple set of each target secondary text class in the target text class, a similarity between the secondary text class corresponding to the target text and each target secondary text class;
determining, based on the text feature of each target text and the tuple set of each other secondary text class in other primary text classes except the target text class in the tuple set, a similarity between the secondary text class corresponding to the target text and each other secondary text class; and
based on the similarity between the secondary text class corresponding to the target text and each target secondary text class and the similarity between the secondary text class corresponding to the target text and each other secondary text class, determining whether the new secondary text class is to be inserted in the target text class.

13. A text classification apparatus, comprising:
a text acquisition module configured to acquire a text to be classified;
a feature extraction module configured to obtain a feature representation of the text to be classified by performing feature extraction on the text to be classified;
a set acquisition module configured to acquire a tuple set of each current text class, the tuple set of each text class comprising a prototype of each respective text class and a distribution density of text data of each respective text class; and
a text classification module configured to obtain a text class of the text to be classified by classifying the text to be classified based on the feature representation of the text to be classified and the tuple set.

14. A non-transitory computer-readable storage medium storing instructions that, when executed by a processor, cause the processor to:
acquire a text to be classified;
obtain a feature representation of the text to be classified by performing feature extraction on the text to be classified;
acquire a tuple set of each current text class, the tuple set of each text class comprising a prototype of each respective text class and a distribution density of text data of each respective text class; and
obtain a text class of the text to be classified by classifying the text to be classified based on the feature representation of the text to be classified and the tuple set.

15. The storage medium of claim 14, wherein the instructions, when executed, further cause the processor to, prior to acquiring the tuple set of each current text class and based on an editing operation for a text class being received:
acquire a target text class corresponding to the editing operation and at least one target text corresponding to the editing operation;
obtain a feature representation corresponding to the at least one target text by performing feature extraction on the at least one target text;
determine a prototype to be updated of the target text class based on the feature representation corresponding to the at least one target text;
determine a distribution density of text data of the target text class based on a text feature of the at least one target text and the prototype to be updated; and
update the prototype to be updated and the distribution density of text data of the target text class into the tuple set.
